(19) United States
(12) Patent Application Publication
(10) Pub. No.: US 2003/0069839 A1
(43) Pub. Date: Apr. 10, 2003

(54) Method for confirming and reporting financial data

(76) Inventors: Barry R. Whittington, Maryland Heights, MO (US); Gary J. Gremminger, Imperial, MO (US); Douglas M. Kennedy, Kirkwood, MO (US)

Correspondence Address: Daniel A. Crowe, BRYAN CAVE LLP, Suite 3600, 211 N. Broadway, St. Louis, MO, 63102-2750, US

(21) Appl. No.: 10/288,894

(22) Filed: Nov. 6, 2002

Related U.S. Application Data
(63) Continuation of application No. 09/665,914, filed on Sep. 20, 2000, now abandoned.
Application No. 09/665,914 is a continuation-in-part of application No. 09/490,651, filed on Jan. 24, 2000.

(51) Int. Cl. G06F 17/60

(52) U.S. Cl. 705/38

(57) ABSTRACT

The Confirmation Express method for confirming and reporting financial data involves several parties. An employee completes an application which typically includes the salary earned by the employee. The application is typically signed by the employee and given to a client, such as a credit card issuing company. The client sends a request to the partner requesting a credit history and confirmation of the salary as listed in the application. The partner, which is typically a credit reporting agency, sends a request to the service provider requesting confirmation of the salary. The employer(s) periodically transmits salary information for the employees to the service provider which uses this data to confirm or deny the accuracy of the salary listed in the application. Confirmation or denial is made within preestablished parameters. Confirmation or denial is sent from the service provider to the partner. The report from the partner to the client contains credit information about the employee and verification or denial that the employment data is accurate within the preestablished parameters. However, the exact salary is never disclosed by the service provider. This report allows the client to make an informed decision concerning the application. The client pays the partner for each report, and this payment is shared by the partner and the service provider. The system can be used by a variety of clients including automobile dealers, rental companies and others. Other alternative embodiments are also disclosed which include direct arrangements between the service provider and the client.

### CROSS REFERENCE TO RELATED APPLICATION

This application is a continuation-in-part of application Ser. No. 09/490,651 filed on Jan. 24, 2000 for “Method for Verifying Employment Data.”

### BACKGROUND OF THE INVENTION

1. Field of the Invention

This invention relates to a business method for confirming and reporting financial data over the Internet.

2. Prior Art

When a person applies for a home loan, they typically fill out a credit application and submit it to a mortgage company. This application requires the applicant to disclose personal financial information including bank account numbers and balances, loan payments, credit card account numbers and balances, employment history, current salary and perhaps other information.

Mortgage companies have typically compared the financial information in the credit application with financial information obtained from a service provider. Some mortgage companies input this financial information into various formula to produce a numeric credit score. However, verification of current salary and employment data was more difficult. Mortgage companies were often forced to make direct contact with the employer to obtain and verify current employment data. This verification process with the employer typically required a written inquiry from the mortgage company to the employer and a written response from the employer to the mortgage company. This written verification process for salary and employment data was time-consuming and sometimes subject to fraud. It was also expensive because employers with thousands of employees were required to dedicate a portion of their human Resources Department to the verification process.

In 1994, TALX Corporation, the assignee of the present application, pioneered a new method of doing business whereby this written verification process (which was previously accomplished by the employer's Human Resource Department) could be out-sourced. This new verification system was called The Work Number®. This verification system allowed the mortgage company to contact TALX over a touch-tone telephone and verify the current salary and employment data for the loan applicant. In exchange for this information, the mortgage company paid TALX a transaction fee.

This touch-tone verification system had great appeal to large employers because it reduced operating expenses and headaches in the Human Resources Department. This touch-tone verification system had great appeal to mortgage companies because it was faster than the old written system and it was less subject to fraud. Because of these advantages, a large number of the Fortune 100 companies have adopted the Work Number verification system as the preferred means for salary and employment verification.

This sort of verification system is useful to a number of different companies, which extend credit to consumers. For example, apartment rental companies will often access the system to verify employment data before signing a property rental agreement. Furniture companies and subprime lenders will often access the system to verify employment data before signing a loan. All of these different companies that access The Work Number verification system to confirm employment data will hereinafter be generically referred to as “verifiers.”

The TALX Work Number verification system introduced in 1994 allowed an employer to provide employment data via magnetic tape or over a telephone line via a modem which was loaded to a database. When employees applied for a loan which required a comprehensive disclosure of employment data, they would call TALX over the telephone and be orally given a salary key code (“SKC”). The employee orally disclosed the SKC over the telephone or face-to-face to the verifier. The verifier then called TALX over the telephone to access the Work Number database. Once connected over the telephone, the verifier entered the SKC and other identification data using the keypad of a touch-tone telephone. If the inquiry was authorized, TALX would issue a report containing employment data to the verifier using interactive voice response technology and, as an option, could also automatically fax the report to the verifier. The TALX end of the transaction was automated. The verifier end of the transaction was initiated by a person who made numeric entry of data using the keypad of a touch-tone telephone.

When employees applied for a loan which required minimal disclosure of employment data, a less comprehensive report was prepared by TALX and given to the verifier. When the report contained only a minimal amount of employment data, the SKC was not required by TALX. In this situation, the verifier entered identification data (but not a SKC) using the keypad of a touch-tone telephone. If the inquiry were authorized, TALX would issue a report containing minimal employment data to the verifier using interactive voice response technology and, as an option, could also automatically fax the report to its verifier.

Most verifiers required a faxed report so they would have a hard copy in their file. Many verifiers would not authorize a loan, or other transaction until the hard copy had been received at the verifier's office. Unfortunately, this often presented delivery problems because of a limited number of fax machines at the verifier's office, which were often busy. This slowed the process down and caused problems at the service provider because it had to revisit the transmission issue when the fax was not delivered.

To overcome these delivery problems, TALX decided to reconfigure The Work Number verification system so that it would also be accessible over the Internet (a.k.a. worldwide web.) This would bypass the fax machine bottleneck and allow the verifier to print a hard copy of the report at their office. Initially, TALX intended to modify proprietary TALX software to make The Work Number verification system Internet accessible. The task was laborious and time-consuming, even with the help of outside consultants. Unfortunately, this approach did not work and it was abandoned in favor of off-the-shelf software and hardware. This course correction delayed the project even further.

The task was still daunting and the web site proved to be unstable during internal testing. The web site would repeatedly crash and further modifications were made. Finally, on Jan. 25, 1999, a press release was issued by TALX Corporation announcing to the world that the Work Number verification system was now accessible over the Internet. Even this announcement proved to be premature. The web site continued to have problems and further changes were made before the web site became stable in the summer of 1999.

In conclusion, confirmation of employment data by verifiers has moved through various evolutionary phases. a) For decades verification was a time-consuming, expensive process that typically required the exchange of one or more letters between the verifier and the employer. b) In 1994, TALX introduced a service provider concept that allowed employment data to be verified using a touch-tone keypad with interactive voice response. In most situations, a hard copy of the report was also faxed to the verifier. c) In 1999, TALX perfected a new service provider concept that allowed employment data to be verified over the Internet, which bypassed the fax machine bottleneck that was often encountered at busy verifiers.

Over time, it became apparent that the Work Number verification system could be improved. In 2000, TALX introduced a new system called Confirmation Express™ which does not use a salary key code. Under the Confirmation Express system, a service provider, such as TALX enters into a contractual relationship with a partner which is typically a credit reporting agency, such as Experian. In the best mode, the service provider and the partner exchange data over a frame relay private network. The partner has contractual relationships with various clients such as credit card issuing companies, automobile dealers and rental companies. The employee makes an application for a credit card or a loan from the client. The application typically requires the employee's signature and disclosure of various types of financial information and employment data. Typically the salary of the employee is disclosed.

In order to confirm the financial information, employment data, and salary, the client sends a request to the partner. The partner sends the salary information from the application to TALX which confirms or denies the accuracy of the salary information within certain parameters, but the exact salary is not disclosed. A typical parameter is 10% of salary. If the reported salary is not overstated by more than 10% of the actual salary it will be confirmed. For example, using a 10% parameter, if the employee reports $10,000 on the application, but only makes $9,000 in actual salary, the accuracy of the salary data will be denied by the service provider and this denial will be included in the report from the partner to the client. Using a 10% parameter, if the employee reports $9,900 or less on the application but only makes $9,000 in actual salary, the accuracy of the salary data will be confirmed by the service provider and this confirmation will be included in the report from the partner to the client. If the employee actually makes $100,000 but only reports $50,000 on the application, it likewise will be confirmed because the parameter only applies to over statement of salary by the employee. Assignment of the parameter is determined by the partner.

After the salary information has been confirmed or denied, the partner sends this data along with a credit report back to the client who makes the ultimate decision on whether to grant or deny the application.

The client pays the partner for this information and a portion of the payment is remitted by the partner to the service provider for confirmation of the salary. No SKC is needed because specific salary information is not disclosed. This simplifies the system and makes it more convenient for the employee.

### SUMMARY OF THE INVENTION

Four parties are typically involved in this verification process for the Work Number System, i.e., the employer, the employee, a verifier and the service provider. Three of these parties maintain computer systems that are capable of communicating over the Internet and, in the best mode, encrypting such data before it is sent. At least one employer periodically loads employment data including, but not limited to, current salary and employment history into a database maintained by a service provider. In the best mode, this loading process occurs over the Internet, however, other less efficient loading modes are within the scope of the invention, including magnetic tape loading and loading of information over a telephone line with a modem.

The employee contacts the service provider and obtains at least one salary key code (SKC), if required. The SKC gives the verifier authority to verify salary information for a single transaction and thus enhances security in the system regarding release of employee salary information. In the best mode, the employee will contact the service provider over the Internet to receive at least one SKC. However, the invention can be practiced in a less efficient mode by the employee if they contact the service provider by telephone.

The employee then discloses at least one SKC to the verifier, if required. In the best mode, the disclosure of the SKC to the verifier occurs over the Internet. However, the invention can be practiced in a less efficient mode whereby the employee discloses the SKC to the verifier orally over the telephone or, in a face-to-face meeting.

Finally, the verifier contacts the service provider web site and enters appropriate identification data and the SKC, if required. The identification data and the SKC are compared against a list of valid SKCs and identification data in the service provider database. If the SKC is valid and the other identification data is valid, the service provider will generate a report to the verifier containing employment information. This report is sent to the verifier over the Internet, preferably in encrypted form. Various types of reports can be generated containing employment data.

In some circumstances, when only minimal employment data is required by the verifier, the SKC is not required. This reduction in security is acceptable to employers and employees when only minimal employment data is being disclosed. In this situation, the verifier enters identification data (but not a SKC) into the service provider computer system. If the inquiry is authorized, the service provider issues a report containing only minimal employment data.

In an alternative embodiment, a governmental agency can access the service provider database to verify information necessary to determine if an applicant qualifies for public assistance. The report to a governmental agency will likewise include employment data. In yet another alternative embodiment, governmental agencies can look up all occurrences of a social security number (“SSN”) on a database for a particular employee.

The verifier pays the service provider for each report that it receives. The cost of the reports varies depending on the amount of information contained therein. The governmental agencies likewise pay the service provider when conducting inquiries concerning applications for public assistance or when conducting a SSN search.

In an alternative embodiment, the employer may assume the function of the service provider and respond to inquiries from the verifier directly. The employer may or may not charge for this verification process.

This invention is efficiently practiced using Active Server Page (ASP) technology well known to those skilled in the art. However, it may also be practiced by the process of downloading Java Script Code to the users. In yet another way, the invention may be practiced by down loading Active X code to the users. Both Java Script and Active X are well known to those skilled in the Art and are within the scope of this invention.

The Confirmation Express system is simpler and more user friendly to the employee because it does not require an SKC. This system typically involves the employer, the employee, the service provider, the partner and the client. The Confirmation Express system verifies, within predetermined parameters, the salary information contained in an application which has been completed by an employee. The service provider either confirms or denies the accuracy of the salary data to the partner and supplies basic employment data, but does not disclose the exact amount of the employee's salary. The partner provides this information along with other credit information to the client. The client makes the ultimate determination whether to accept or deny the application from the employee. The client pays the partner for each report it provides. This payment is shared between the partner and the service provider.

### BRIEF DESCRIPTION OF THE DRAWINGS

The advantages of this invention will be better understood by referring to the accompanying drawings, in which:

FIG. 1 is a block diagram of the relationship between the employer, the employee, the service provider and the verifier.

FIG. 2 is a block diagram of the connection over the Internet between the employer and the service provider when the employer loads employment information. This diagram also contains the hardware configuration that the service provider uses for this purpose.

FIG. 3 is a block diagram of the connection over the Internet between the employee and the service provider when the employee is assigned a SKC. This diagram also contains the hardware configuration that the service provider uses for this purpose.

FIG. 4 is a block diagram of the connection over the Internet between the verifier and the service provider during the verification process. This diagram also contains the hardware configuration that the service provider uses for this purpose.

FIG. 5 is a block diagram similar to FIG. 4 except the verifier is storing data from multiple employers instead of a single employer as shown in FIG. 4 and is simultaneously handling inquiries from multiple verifiers. FIG. 5 is the best mode currently known to applicants.

FIG. 6 is a flowchart of the data loading process by the employer. This flowchart corresponds with the block diagram FIG. 2.

FIG. 7 is a flowchart of the main screen selection process at the service provider.

FIG. 8 is a flowchart of the employee access procedure.

FIG. 9 is a flowchart of the process for assigning a SKC to an employee. This flowchart corresponds with the block diagram FIG. 3.

FIG. 10 is a flowchart for the verifier login at the service provider.

FIG. 11 is a flowchart for the verification process. This flowchart corresponds with the block diagram FIG. 4.

FIG. 12 is a sample report containing minimal employment data.

FIG. 13 is a sample report containing more employment data than the report FIG. 12.

FIG. 14 is a sample report containing more employment data than the reports FIG. 12 and FIG. 13.

FIG. 15 is a flowchart for a governmental agency to login at the service provider.

FIG. 16 is a flowchart for a governmental agency to make verification requests and to request a SSN report.

FIG. 17 is a sample report containing employment data to a governmental agency.

FIG. 18 is a sample SSN report.

FIG. 19 is a flowchart of the employer login at the service provider.

FIG. 20 is a flowchart for various employer functions including blocking employee information, reactivating an employee and placing an employee on inactive status.

FIG. 21 is a flowchart of the process to assign an employee a new personal identification number (PIN).

FIG. 22 is a block diagram of an alternative embodiment of this verification system wherein the employer subsumes the functions of the service provider and deals directly with the verifier.

FIG. 23 is a block diagram of the alternative embodiment of FIG. 22 showing the connection over the Internet between the employer and the verifier during the verification process. This diagram also contains the hardware configuration that the employer uses for this purpose.

FIG. 24 is a block diagram of another alternative embodiment wherein the employment data is stored on a database maintained by the employer, but the verifier accesses the employment data via a service provider. This diagram also contains the hardware configuration that the service provider and employer use for this purpose.

FIG. 25 is a block diagram of the relationship between the employer, the partner, the service provider and the Client.

FIG. 26 is a block diagram of the connection over the Internet between the employer and the service provider when the employer loads employment information. This diagram also contains the hardware configuration that the service provider uses for this purpose.

FIG. 27 is a block diagram of the connection over the Internet between the client and partner and over a Frame Relay connection between the partner and the service provider during the confirmation process. This diagram also contains the hardware configuration that the service provider uses for this purpose.

FIG. 28 is a block diagram similar to FIG. 27 except the service provider is storing data from multiple employers instead of a single employer as shown in FIG. 27 and is simultaneously handling inquiries from multiple clients and partners. FIG. 28 is the best mode currently known to applicants.

FIG. 29 is a flowchart of the data loading process by the employer. This flowchart corresponds with the block diagram FIG. 26.

FIG. 30 is a flowchart of the main electronic interface process at the service provider.

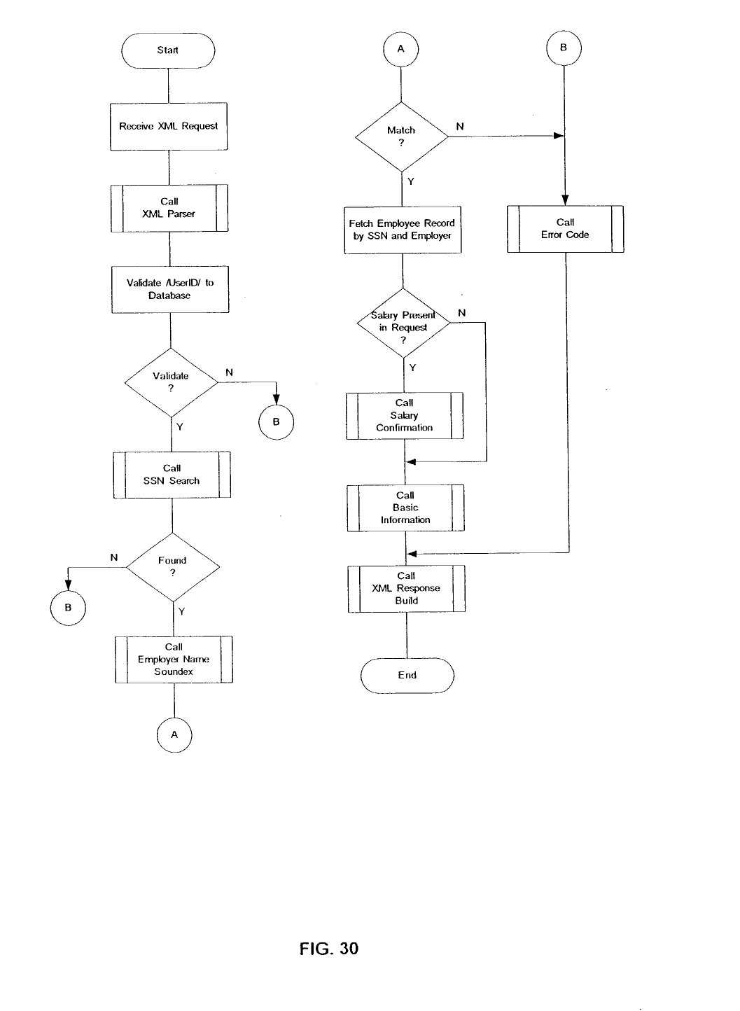

FIG. 31 is a flowchart of the XML request process.

FIG. 32 is a flowchart of the Social Security Number lookup process.

FIG. 33 is a flowchart for the employer name recognition.

FIG. 34 is a flowchart for the confirmation process and annualization of salary data.

FIG. 35 is a flowchart for interface error handling.

FIG. 36 is a flowchart of adding basic employee data to a XML response to a confirmation request.

FIG. 37 is a flowchart for building an XML response to a confirmation request.

FIG. 38 is a block diagram of an alternative embodiment without the use of a Frame Relay connection.

FIG. 39 is a block diagram of an alternative embodiment without the use of a Frame Relay connection and no partner involved.

FIG. 40 is a block diagram of an alternative embodiment with the use of a Frame Relay connection and no partner involved

FIG. 41 is a block diagram of an alternative embodiment where employee data and salary data are stored at the employer's site rather then the service provider.

FIG. 42 is a block diagram of an alternative embodiment where employee data and salary data are stored at the employer's site rather then the service provider and no partner or Frame Relay connection is used. This figure also contains the hardware used by the employer for this purpose.

FIG. 43 is a block diagram of an alternative embodiment where employee data and salary data are stored at the employer's site rather then the service provider and no partner or Internet connection is used. This figure also contains the hardware used by the employer for this purpose.

FIG. 44 is a table describing the input definition for a confirmation request.

FIG. 45 is a continuation of FIG. 44

FIG. 46 is a table describing the confirmation output response definitions to a confirmation request.

FIG. 47 is a continuation of FIG. 46

FIG. 48 is a continuation of FIG. 46

FIG. 49 is a continuation of FIG. 46

FIG. 50 is a continuation of FIG. 46

FIG. 51 is an example of an XML confirmation input request stream.

FIG. 52 is the confirmation XML request stream Data Type Definition (DTD).

FIG. 53 is an example of an XML confirmation response stream to a confirmation request.

FIG. 54 is the XML confirmation output stream Data Type Definition (DTD).

FIG. 55 is a table describing confirmation output response code definitions for various XML fields. These response codes include error codes, as well as informational message codes.

### DESCRIPTION OF THE PREFERRED EMBODIMENT

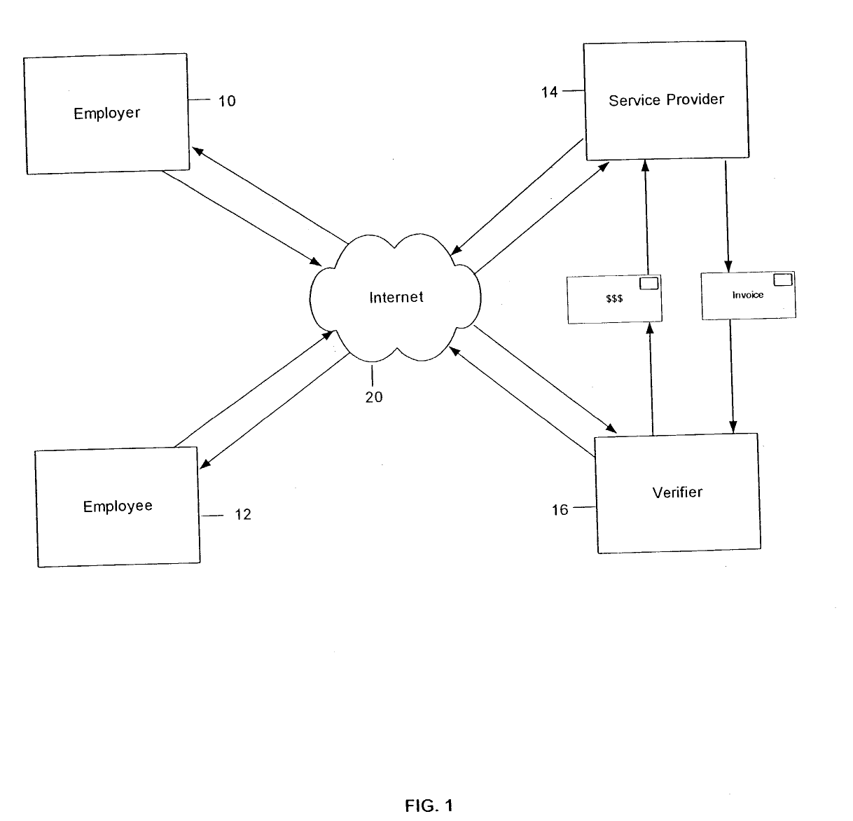

FIG. 1 is a block diagram indicating the overall relationship between the employer 10, the employee 12, the service provider 14 and the verifier 16. The arrows in the diagram indicate the exchange of data between the parties over the Internet 20. The employer 10 transmits employment data over the Internet 20 to the service provider 14. In the preferred embodiment, the employer 10 encrypts the data before it is sent to the service provider 14.

The employee 12 fills out a credit application and gives it to the verifier 16. The credit application requires disclosure of the name of the employer 10, the employee's 12 SSN and other financial information. The employee 12 contacts the service provider 14 over the Internet 20 and requests a salary key code (SKC), if required. The employee 12 then contacts the verifier 16 over the Internet 20 and discloses the SKC to the verifier 16. The verifier 16 then contacts the service provider 14 over the Internet 20, inputting the SKC and other identification data. The service provider 14 compares the SKC and the identification data against a list of valid SKCs and valid identification data to determine if the verifier 16 should receive a report containing employment data from the service provider 14. If the verifier 16 can demonstrate proper authority by inputting a valid SKC and valid identification data, the service provider 14 generates a report and sends the report over the Internet to the verifier 16. In the preferred embodiment, the report is encrypted and then sent to the verifier 16. The verifier 16 will typically print a hard copy of the report on a printer at their office for inclusion in the employee's 12 loan application file.

Although it is less efficient, the employer 10 may also transmit data to the service provider 14 via magnetic tapes, or over the telephone lines via a modem. In the preferred embodiment, transmission of employee data occurs over the Internet 20. In a less efficient version of this invention, the employee 12 can also acquire an SKC from the service provider 14 over the telephone. In the preferred embodiment, the transaction between the employee 12 and the service provider 14 occurs over the Internet 20. All interactions between the service provider 14 and the verifier 16 occur over the Internet 20.

The employer 10 can also obtain data from the service provider 14 such as real time system activity reports which include a total of SKCs issued to their employees, a total of verification reports performed against their employees 12, and other information. Further, the employer 10 may access the system's employee 12 maintenance functions to block/unblock an employee's 12 record, check and/or change an employee's 12 status code, and check and/or change the termination date for an employee 12.

The verifier 16 is charged a transaction fee for each report prepared by the service provider 14. The service provider 14 maintains accurate records and prepares periodic invoices which are typically mailed to the verifier 16. These invoices can also be delivered electronically and payments can be made by check, credit card, wire or any other means acceptable to the verifier 16.

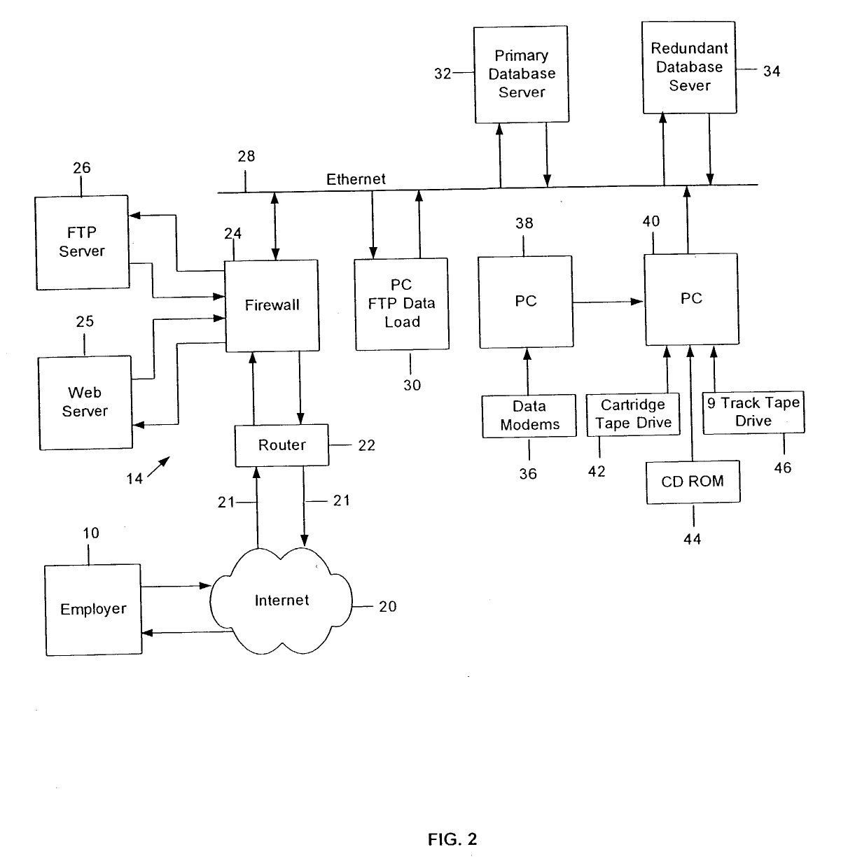

FIG. 2 is a block diagram showing the connection between the employer 10 and the service provider 14 over the Internet 20 when the employer 10 transfers employment data to the service provider 14 computer system. The employer 10 establishes a connection in conventional fashion with the Internet 20 in order to connect with the service provider 14. The service provider 14 is connected to the Internet 20 by pipes 21 which could be T1 lines or other types of connections. The pipes 21 connect to a router 22. Applicant has found that a Cisco 3620 router is suitable for this purpose. These routers are available from Cisco Systems of Santa Clara, Calif. The data is then transferred from the router 22 through a firewall 24. Applicant has found that a Sun Solaris server is suitable to be used as the firewall 24, running a Sun 0S 5.6 operating system with McAffee anitivirus protection and Check Point Firewall software. The Sun Solaris Server is available from Sun Microsystems of Palo Alto, Calif. The McAfee software is available from Network Associates of Santa Clara, Calif. The Check Point Firewall software is avilable from Check Point Software Technologies of Redwood City, Calif. The data moves through the firewall 24 to the File Transfer Protocol (FTP) server 26. Applicant has found that the following hardware and software are suitable for the FTP server 26: Intel ALT server available from Intel Corporation of Santa Clara, Calif.; and Redhat Linux 6.0 operating system available from Redhat of Durham, N.C. The data is temporarily stored in the FTP Server in a user name, password protected directory. Each employer 10 utilizing this preferred method of data transfer is assigned such an account.

When the data is retrieved from FTP server 26 in prepartion for loading to primary database server 32, the data then goes back through the firewall 24 to the ethernet 28. Other types of networks could also be suitable including a token-ring. Various types of network topologies are well known to those skilled in the art and are within the scope of this invention. The data passes across ethernet 28 to a workstation 30 for loading of the FTP data. Applicant has found that the following hardware and software are suitable for the workstation 30: a Portland personal computer (“PC”) available from Intel Corporation of Santa Clara, Calif.; running Microsoft Windows NT 4.0 operating system available from Microsoft Corporation of Redmond, Wash. Additionally workstation 30 has the following software installed to be run as required: PGP Encryption/Decryption software available from Network Associates of Santa Clara, Calif.; PKZip data compression software available from PKWARE Incorporated of Brown Deer, Wis. and IBM Compress data encryption\decryption software available from IBM of Armond, N.Y. In preparation for loading, data is decrypted using appropriate software discussed above. The data then moves along the ethernet 28 to the primary database server 32 and is copied to redundant database server 34. Anytime data is stored in primary datase server 32 it is also copied to redundant database server 34. Applicant has found that a Compaq Proliant 7000 server running MS Windows NT 4.0 as an operating system and the Oracle 8.05 database system works well for this purpose. The Proliant servers can be obtained from Compaq Computers of Houston, Tex. The MS Windows NT can be obtained from Microsoft of Redmond, Wash. and the Oracle software can be obtained from Oracle of Redwood Shores, Calif. A redundant database server 34 also connects to the ethernet 28 in case of any problems with the primary database server 32. The same hardware and software used for the primary database server 32 also work well for the redundant database server 34.

In review, employment data from the employer 10 is routed over the Internet 20. The data arrives at the service provider 14 and is transmitted via pipes 21 to router 22. The data then moves from the router 22 to the firewall 24 and into the FTP server 26. The data then moves back through the firewall 24 to the ethernet 28 to workstation 30 where it is then prepared for loading. The data then moves back over the ethernet 28 to the primary database server 32 and the redundant database server 34 where it is stored.

Although not as efficient as loading data over the Internet 20, the employer 10 can also load data over the telephone lines via the data modem 36 where it is received by workstation 38. Data received is temporarliy stored in a user named, password protected directory. Applicant has found that U.S. Robotic 28.8 modems are suitable for this application. The modems can be obtained from 3-Com Corporation of Santa Clara, Calif. Applicant has determined that the following hardware and software are suitable for the workstation 38: an Intel Portland PC with Microsoft Windows NT 4.0 operating System, PGP software for data encryption, IBM Compress software for data encryption and compression, PK Zip for data compression, Hyper Access 5.0 modem control software and McAffee Virus for virus protection. These products can be obtained from the following vendors: Intel Portland PC from Intel Corporation of Sata Clara, Calif., Hyper Access 5 modem control software from Hillgraeve of Monroe, Mich., PGP 6.5 encryption software available from Network Associates of Santa Clara, Calif.; IBM compress software available from IBM of Armond, N.Y.; PKZIP available from PKWARE Incorporated Brown Deer, Wis., and McAffee Anti-virus 4.0.4, available from Network Associates of Santa Clara, Calif. Employer 10 data is uncompressed or decrypted as appropriate, scanned for viruses, prepared for loading, and moved across a dedicated link through workstation 40 across the ethernet to primary datbase server 32 and redundant database server 34 where the data is stored. A dedicated link to workstation 40 is used to insure that access to TALX internal networks is not possible via modem and completly under the control of the firewall 24.

Applicant has determined that the following hardware and software are suitable for the workstation 40: an Intel Portland PC available form Intel Corporation of Sata Clara, Calif. running MS Windows NT 4.0 operating system available from Microsoft Corporation of Remond, Wash.

In review, data from the employer 10 can be transmitted through the data modem 36 which is then prepared for loading at the workstation 38 and transmitted through the workstation 40 through the ethernet 28 and is thereafter stored on the primary database server 32 and the redundant database server 34.

In the alternative, the employer 10 can also supply employment data through 9 track magnetic tape via tape drive 46. Applicant has found that the following equipment is suitable for tape drive 46: Qualstar 3412S 9-track tape drive, available from Qualstar Corporation of Canoga Park, Calif. with PC workstation 40 running Nova Xchange 2.00 software from Novastar Corporation of Simi Valley, Calif. In another alternative, the employer 10 can supply employment data through cartridge magnetic tape via multi cartridge tape drive 42. Applicant has found that the Xcerta VDS MS-843 EWS-XL multi-cartridge magnetic tape unit available from Comco Incorporated of Bettendorf, Iowa with PC workstation 40 running Nova Xchange 2.00 software from Novastar Corporation of Simi Valley, Calif. is suitable for this purpose. In another alternative the employer 10 can supply employment data on CD ROM via CD ROM drive 44. Applicant has found that the following equipment is suitable for the CD ROM 44: Sony 8× CD from Sony Electronics, Inc. of Park Ridge, N.J.

Suitable backup systems for the primary database server 32 and redundant database server 34, known to those skilled in the art, are also used in this system but are not shown in the drawings.

In review, data loaded on the 9-track tape drive is prepared for loading at workstation 40, is transmitted over the ethernet 28 and stored in the primary database server 32 and the secondary database server 34. Likewise, data loaded by the CD ROM 44 and the cartridge tape drive 42 is prepared for loading by the PC workstation 40 and is transmitted via the ethernet 28 to primary database server 32 and redundant database server 34. Other types of data transfer methods that may be used to transfer data from the employer 10 to the service provider 14, are within the scope of this invention, and are known to those skilled in the art.

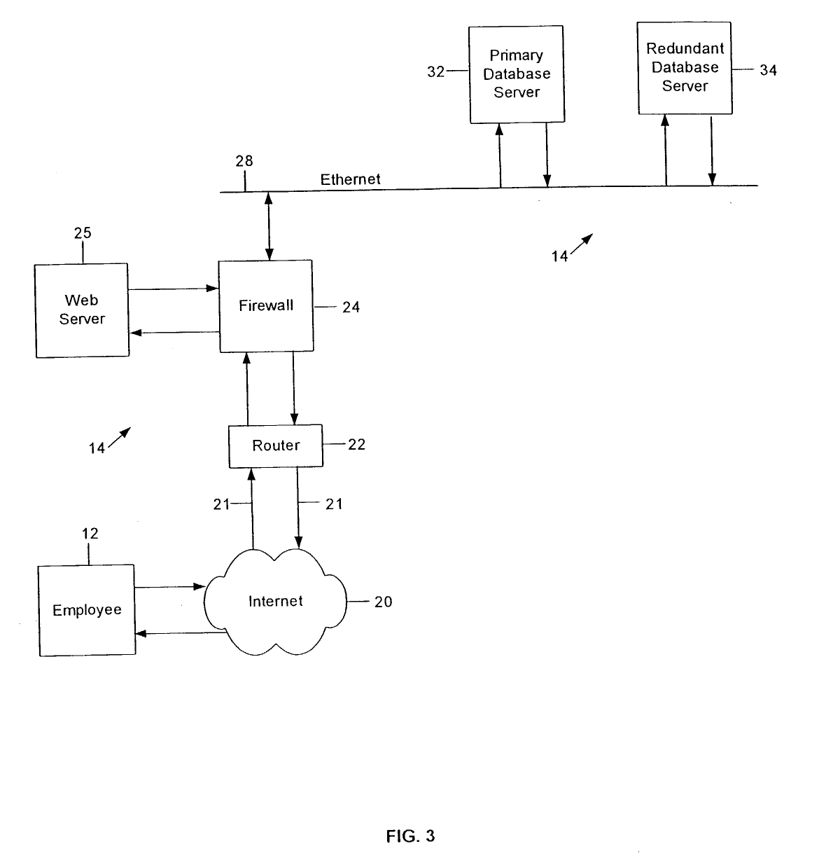

FIG. 3 is a block diagram showing the connection between the employee 12 and the service provider 14 over the Internet when the employee is assigned a SKC.

In the best mode, employee 12 gains access to the Internet 20, and enters the domain name (Uniform Resource Locator) for the service provider 14 web site. Data from pipes 21, moves through the router 22 into the firewall 24 and into the web server 25. The URL currently used by TALX is www.theworknumber.com. Applicant has successfully used the following hardware and software for the web server 25: Intel Madronna server available from Intel Corporation of Santa Clara, Calif. running Microsoft Windows NT 4.0 operating system and Microsoft Internet Information Server 4.0 (IIS) web application engine.

When the URL is entered, the main selection screen, (home page) is displayed to the employee 12. When the employee 12 selects the employee 12 login function the connection between the employee 12 and the service provider 14 is encrypted using Secure Socket Layer (SSL) technology with 40 bit encryption. This technology is native to web browser software and well known to those skilled in the art. Other types of encryption methods known to those skilled in the art are within the scope of this invention. The employee selects their company via a drop down menu, enters their SSN, and their PIN. The web application then compares the employee PIN entered to the PIN stored on the primary database 32 and redundant database 34. If the company, SSN and PIN match the data in the database, the employee is validated and allowed access. The employee may select to receive an SKC; the web application randomly generates at least one SKC that is assigned to that employee, writes a record of the transaction through firewall 24 to the ethernet 28 and stores it on primary database server 32 and transmits the SKC as indicated by the arrows, to the employee 12. In the present configuration, the employee can request up to three SKCs at a time. This is important because an employee may be making concurrent loan applications through several mortgage companies in an effort to locate better rates or for other reasons.

In review, the SKC is a number that is randomly generated by the service provider 14. The service provider 14 typically generates thousands of valid SKCs which are stored in the primary database server 32 and redundant database server 34. Each unique SKC is valid for only a single transaction. In other words, once a unique SKC is used, it cannot be re-used or re-assigned by the employee, the service provider, or another verifier. In a less efficient fashion, the employee may also contact the service provider 14 over the telephone to receive at least one SKC.

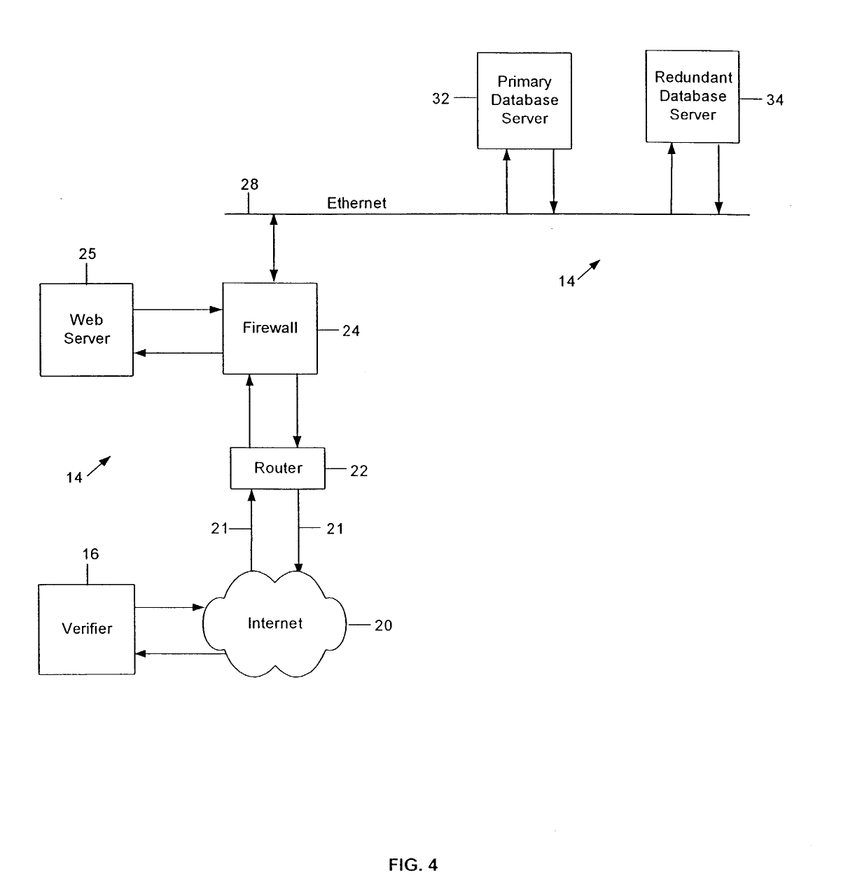

FIG. 4 is a block diagram of the verification process. The verifier 16 gains access to the Internet 20 and enters the URL for the service provider 14 web site. The URL request from the verifier 16 is transmitted via pipes 21 to router 22 through firewall 24 to web server 25. The verifier sees the home page for the service provider 14 and with sufficient prompts, moves to another screen for entering identification data and the SKC. When the verifier 16 selects the verifier 16 login option the connection between the verifier 16 and the service provider 14 is encrypted using Secure Socket Layer (SSL) technology, with 128 bit encryption. This technology is native to web browser software and well known to those skilled in the art. The service provider 14 may also use other encryption methods well known to those skilled in the art. Once the data are entered by the verifier 16, it will be compared against valid identification data and valid SKCs for that employee 12 fetched from primary database server 32 via the ethernet 28 through firewall 24 and loaded to the web application on web server 25. If the information entered by the verifier 16 can be validated against the identification data and the SKC in the database 32, a report will be generated by the web application on web server 25 and a transaction record will be written to the primary database server 32 and redundant database server 32, through the Firewall 24 via the ethernet 28. The report is transmitted through the Firewall 24 to the router 22 and through the pipes 21. The report then passes over the Internet 20 to verifier 16.

Various types of reports can be generated depending on the needs of the verifier 16. The reports contain employment and salary data.

If a governmental agency is making an inquiry, a public assistance report is generated. If a governmental agency is seeking all occurrences of a social security number on the database, a social security search report is generated.

In review, the verifier 16 accesses the service provider 14 via the Internet 20, enters employee identification data and, if required, a valid SKC. If all entered data is validated against data stored in primary database server 32 the verifier 16 may order a report on the employee 12. Reports on employees 12 contain varying amounts of information depending on the verifier 16 needs. State governmental organizations may order Public Assistance verification reports as well as a report listing all occurences of the SSN on the primary database server 32 and server 34 for employee 12. The service provider 14 charges for all reports.

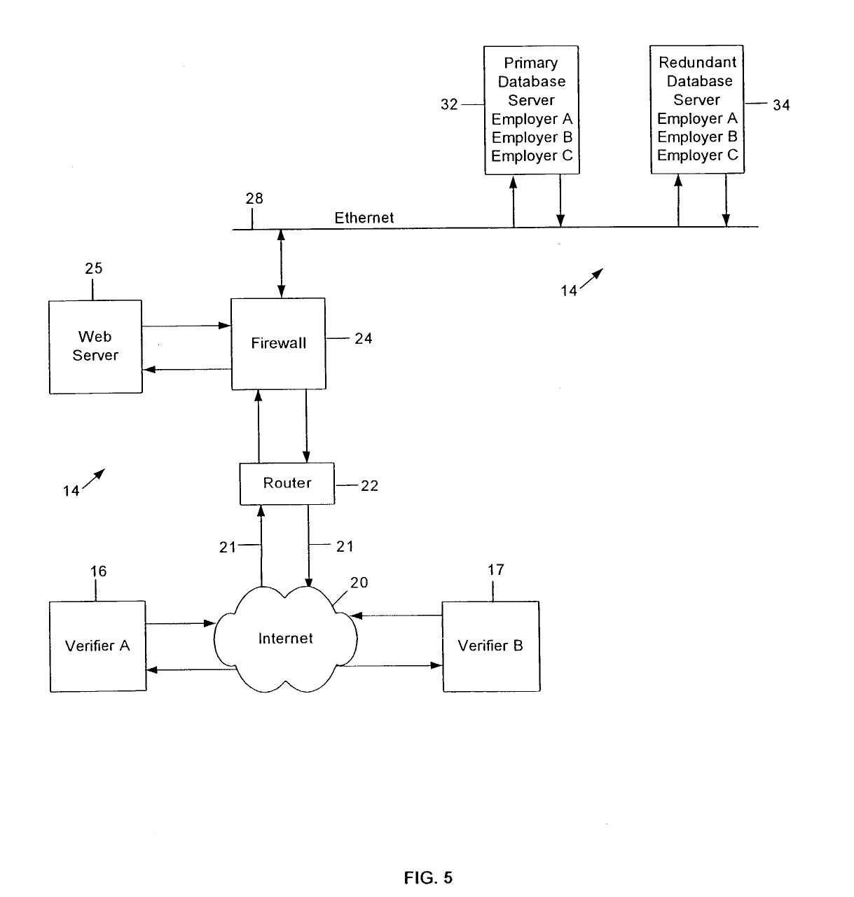

FIG. 5 is a block diagram of the verification system in the best mode as currently known to applicant. Multiple verifiers enter into agreements with the service provider 14 and are able to access the verification system simultaneously over the Internet 20. (Today more than a thousand verifiers have entered into such agreements with TALX and are using this verification system over the Internet 20.) In FIG. 5, multiple verifiers are shown, i.e., verifier A, identified by numeral 16 and verifier B, identified by numeral 17.

Likewise, multiple employers 10 enter into agreements with the service provider 14 and employment data from each employer 10 is stored on primary database server 32 and copied to redundant database server 34 at the service provider's 14 place of business. Today hundreds of employers 10 have entered into such agreements to use this verification system over the Internet 20. Employment data for millions of employees 12 from various employers 10 is securely stored on primary database server 32 and redundant database server 34 at the service provider's 14 place of business.

When each verifier 16 enters into an agreement with the service provider 14, they are assigned specific identification codes, which act as a user name password, so the verifier 16 can login to the verification system. The first ID code is called the Lender ID code which identifies the business entity and the second ID code is called the Verifier ID code which identifies the office or location for verifiers 16 with more than one office. For example, ABC Mortgage Company has several offices throughout the United States. ABC Mortgage Company could be assigned a Lender ID code of 12345678. Each office or location of ABC Mortgage Company would have a unique Verifier ID code. For example, ABC Mortgage Company has an office in Arlington, Va., with a Verifier ID code of 91011. When logging in to the service provider 14, via the Internet 20, the verifier 16, ABC Mortgage Company in Arlington, Va. enters both the Lender ID code, 12345678, and the Verifier ID code, 91011. The service provider 14 is then able to compare these ID codes against valid ID codes stored in the primary database server 32 and validate whether the verifier 16 has proper access to the system. These ID codes identify that the inquiry for employment information is being made by a known and authorized verifier 16 from its Arlington, Va. office. Other types of identification codes are within the scope of this invention.

These verifier 16 ID codes also facilitate proper billing by the service provider 14. A fee is charged by the service provider 14 for each report sent to a verifier 16. A unique transaction ID, known as a reference number, is assigned to each report that is sent to a verifier 16.

In the best mode, multiple employers 10 enter into contracts with the service provider 14 so a plurality of employees 12 can take advantage of this verification system. FIG. 5 is a block diagram similar to FIG. 4 except that the service provider 14 is storing data for multiple employers A, B, and C with thousands of employees 12 and is handling requests from multiple verifiers 16,17 simultaneously. The Work Number verification system that is presently in use at TALX Corporation uses the model shown in FIG. 5. This makes the system more cost-efficient and attractive from the perspective of the service provider 14.

This invention is currently practiced using Active Server Page (ASP) technology well known to those skilled in the art. In the alternative, it may also be practiced by the process of downloading Java Script Code to the users (i.e. employee 10, verifier 16 or employer 10). In yet another way, the invention may be practiced by down loading Active X code to the users. Both Java Script and Active X are well known to those skilled in the art and are within the scope of this invention.

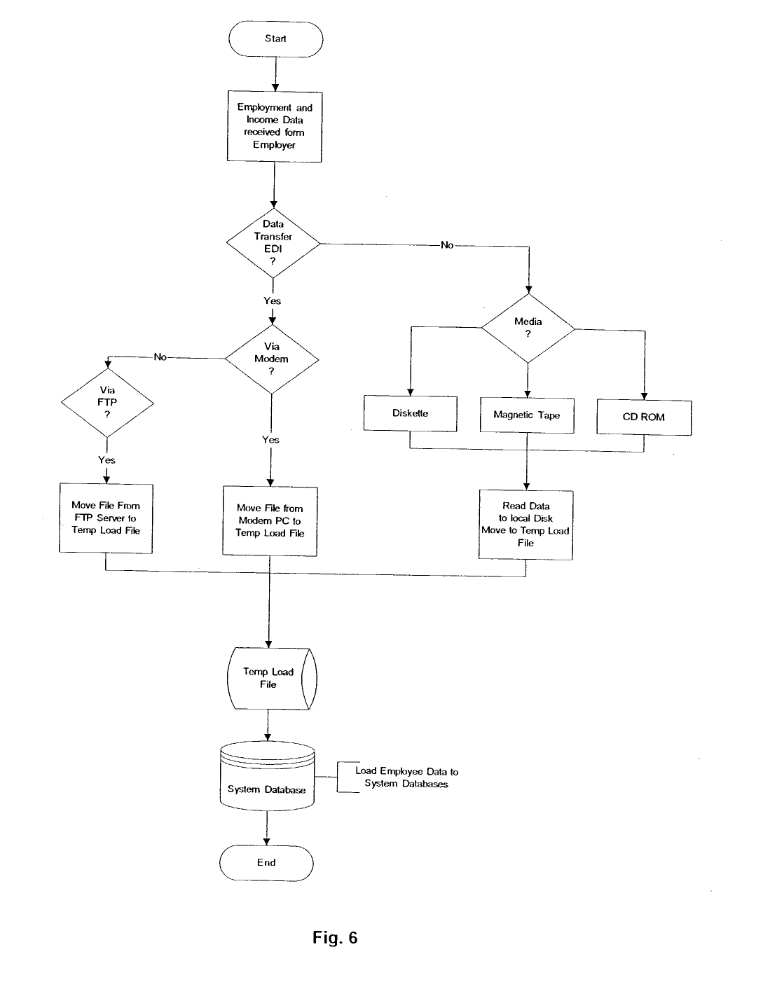

FIG. 6 is a flowchart for the employer 10 data load process described in the block diagram FIG. 2. The system first determines if the employer 10 data is being transferred to the service provider 14 by Electronic Data Interchange (EDI) or some other means. If the data is not being transferred EDI, the data will be transferred either through diskette, magnetic tape or CD ROM to the service provider 14 for loading to the primary database server 32 and the redundant database server 34.

If the employer data is being transferred EDI over a modem, the data moves to workstation 38. If the transferred data is compressed using PKZip, the data is uncompressed and prepared for loading. The data then moves through workstation 40 over the ethernet 28 to a temporary load area in primary database server 32 from where it is loaded to the production database in primary database server 32 and copied via the ethernet 28 to the redudant database server 34.

In the best mode, the employer 10 data is tranferred via the Internet 20 through the pipes 21, through router 22, through firewall 24 to FTP Server 26, utilizing File Transfer Protocol (FTP). The data is then moved from the FTP server 26 through the firewall 24 to the FTP Data Load 30 via the ethernet 28. If the received employee data is in encrypted form it is decrypted using the appropriate decryption software and prepared for loading. The data is then loaded via the ethernet 28 to a temporary load area on primary database server 32 from where it is loaded to the production database on the primary database server 32 and copied via the ethernet 28 to the redundant database server 34.

For purposes of claim interpretation the term “employment data” may include, but is not limited to, company identification code, employee PIN, SSN, employment status, i.e., actively employed, retired, no longer employed, etc.; most recent start date; total time with employer; current title; rate of pay, i.e., weekly, biweekly or monthly, etc.; average hours worked; total dollars paid, year to date; total dollars paid for prior years; last pay date and other types of employment data.

All of this employment data is stored in the primary database server 32 and is copied to the redundant database server 34. This employment data is transferred by the employer 10 periodically, typically following each pay period, so as to maintain the most accurate information possible. Transferring of employment data by the employer 10 does not require access to the service provider's 14 web site.

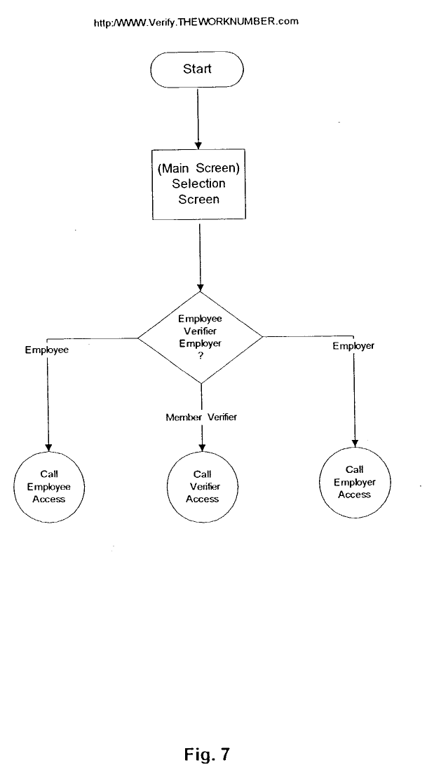

FIG. 7 is a flowchart that explains how the software functions when an employee 12, verifier 16 or employer 10 makes a connection over the Internet 20 with the service provider's 14 web site. Once the connection has been established, the main screen (home page) is displayed for the employee 12, the verifier 16 or the employer 10 presenting three distinct options. The employee 12 may login to the employee 12 portion of the system for obtaining a SKC. The verifier 16 may login to the verifier 16 portion of the system to obtain reports with employment data. The employer 10 may login to the system to update employee status and perform file maintenance.

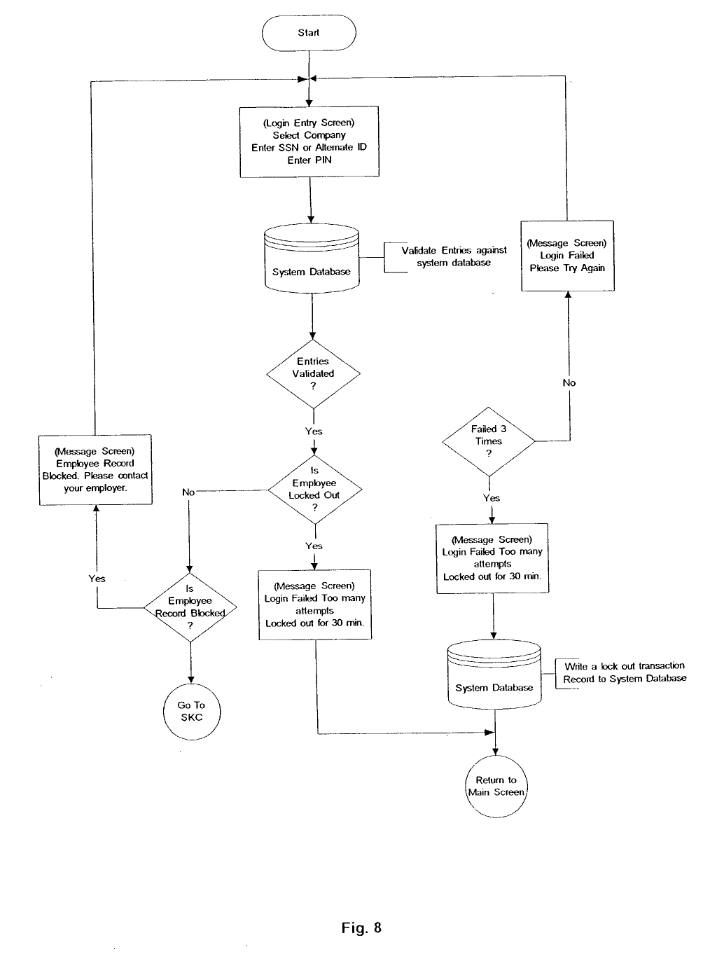

FIG. 8 is a flowchart explaining the employee 12 login procedure. After the employee 12 makes a selection, an employee login screen will be displayed to the employee 12. The employee login screen displays a drop-down menu containing a list of all employers. The employee selects their employer. Each employer has a distinct Company Code number which the sytsem utilizes based upon the employee's employer selection. The employee 12 login screen also displays several input fields including the employee's SSN and the employee's personal identification number (PIN). After the employee 12 has selected their company and entered their SSN and PIN, the system will compare these entries against valid company codes, SSN and employee PIN numbers in the primary database 32. If the information entered by the employee 12 is validated against corresponding information in the service provider 14 primary database 32, another screen will be presented to the employee whereby he can view active (unused) SKCs, request or delete one or more SKCs, and change their PIN. During the employee 12 login process an employee 12 may make up to three attempts to login. If for whatever reason, i.e., mis-typed, forgotten PIN, etc., login is not achieved the employee 12 sees a message screen that the login attempt was unsuccessful and he may make another attempt. If after three attempts the employee 12 has not sucessfully logged in, the employee 12 sees a message screen telling them that they are locked out of the system for a period of thirty minutes. The web application writes a lock out record for this employee 12 to the primary database 32 as previously described. Upon the next attempt to login, the system compares the date and time stamps on any lock out records for the employee 12 to the system date and time. If at least thirty minutes have passed since the lock out record was written, the employee 12 may attempt to log into the system. If at least thirty minutes have not passed the employee sees a lock out message screen. This lock out feature enhances employee 12 security by preventing long periods of login attempts for the purpose of trying unlimited combinations of ID information, either manually or via a software program, to discover valid combinations of employee 12 ID information and surreptitiously gain system access.

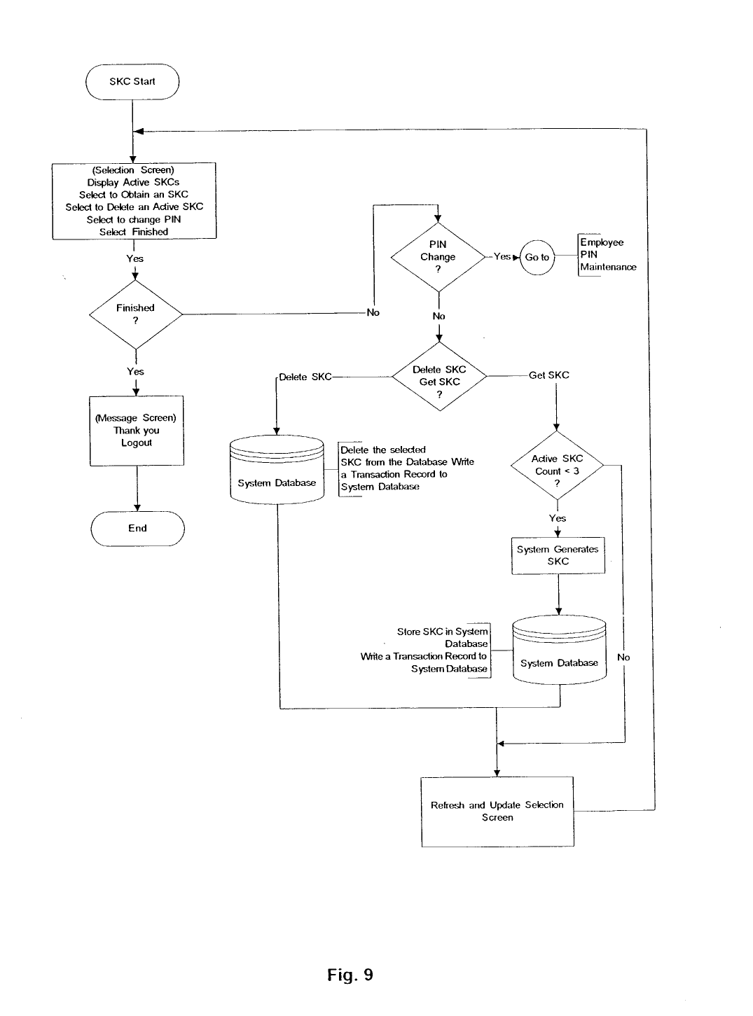

FIG. 9 is a flowchart of the system software for assigning one or more SKCs to an employee 12 or deleting one or more SKCs previously assigned. The screen displays active (unused) SKCs. The screen prompts the employee 12 to request or delete an SKC. One or more SKCs are then displayed on the screen for the employee 12 or one or more SKCs disappear from the screen. After the employee 12 finishes selecting or deleting SKCs, they select “finish” and see a “thank you” message screen.

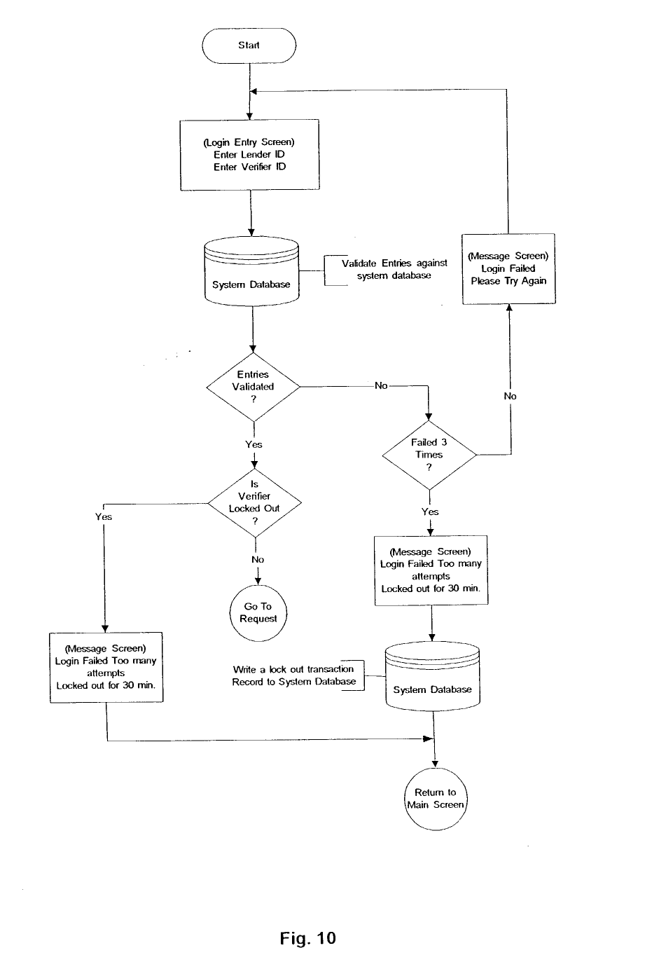

FIG. 10 is a flowchart for the verifier 16 login procedure. A verifier 16 goes from the main menu (home page) to a verifier 16 login screen which has several input fields including the lender ID and the verifier ID. The lender ID is a preassigned number for a verifier which may have multiple offices throughout the United States. The verifier ID is a separate number for each individual office. After the lender ID and the verifier ID have been entered into the input fields, the system compares this identification data with valid lender ID numbers and verifier ID numbers in the database. If the lender ID and the verification ID are valid, another screen will be presented to the verifier 16. During the verifier 16 login process a verifier 16 may make up to three attempts to login. If for whatever reason, i.e., mis-typed lender ID, or forgotten verifier ID, etc, login is not achieved the verifier 16 sees a message screen telling them the login failed and allows them to attempt another login. After three attempts the verifier 16 sees a message screen telling them that they are locked out of the system for a period of thirty minutes. The web application writes a lock out record for this verifier 16 to the primary database 32 as previously described.

Upon the next attempt to login, the system compares the date and time stamps on any lock out records for the verifier 16 to the system date and time. If at least thirty minutes have passed since the lock out record was written, the verifier 16 may again attempt to log into the system. If at least thirty minutes have not passed the verifier 16 sees a lock out message screen and is not allowed to attempt login. This lock out feature enhances verifier 16 security by preventing long periods of login attempts for the purpose of trying unlimited combinations of ID information, either manually or via a software program, to discover a valid combination of lender ID and verifier ID and to surreptitiously gain system access. Other types of lock out methodology known to those skilled in the art are within the scope of this invention.

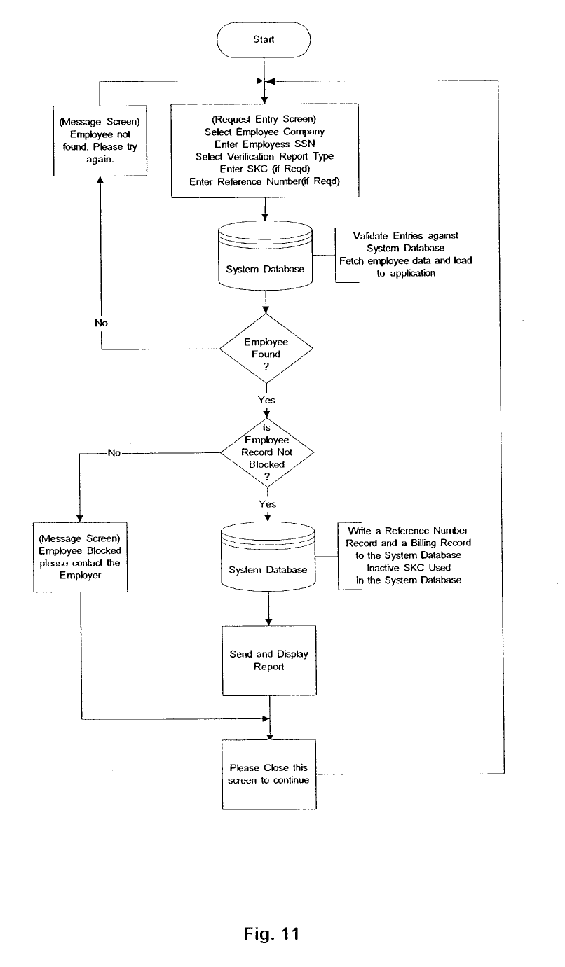

FIG. 11 is a flowchart of the software program for the verification request process, including generation of a report. After the verifier 16 has appropriately logged in, the verification screen displays a drop-down menu containing a list of all employers 10. The verifier 16 selects the appropriate employer 10 for a specific employee 2. Several input fields are displayed including, employee SSN, the type of report requested, and the SKC. Again, the system compares this identification data with valid identification data in the database. If the information that has been entered in the various input fields corresponds to valid identification data in the database, the verifier 16 will be issued a report as requested. The report will be sent to the verifier 16 over the Internet 20, as previosly described. The service provider 14 generates a standard report containing employment data and transmits the report to the verifier 16. The format and content of standard reports are selected by the service provider 14 but the verifier 16 selects the type of report it needs. In practice, applicant has found it useful to offer a variety of standard reports at different price points. The verifier 16 can then select the type of standard report that is most practical for their particular purpose and then pays the verifier for each report.

Applicant currently offers three standard reports to verifiers 16 called Basic, Basic+, and Full, as well as other reports for governmental agencies. The Basic report has the lowest price point, Basic+ has an intermediate price point and the Full report is the most expensive. A mortgage company that is contemplating a large home loan may be willing to pay for the Full report. In contrast, a furniture company that is making a loan for a sofa may only be willing to pay for the Basic report. Offering several different types of reports at different price points gives the verifier 16 a choice. A description of these three standard reports follows. Other reports with different types of employment data are also within the scope of this invention. These reports are therefore mere examples and not limitations on the invention.

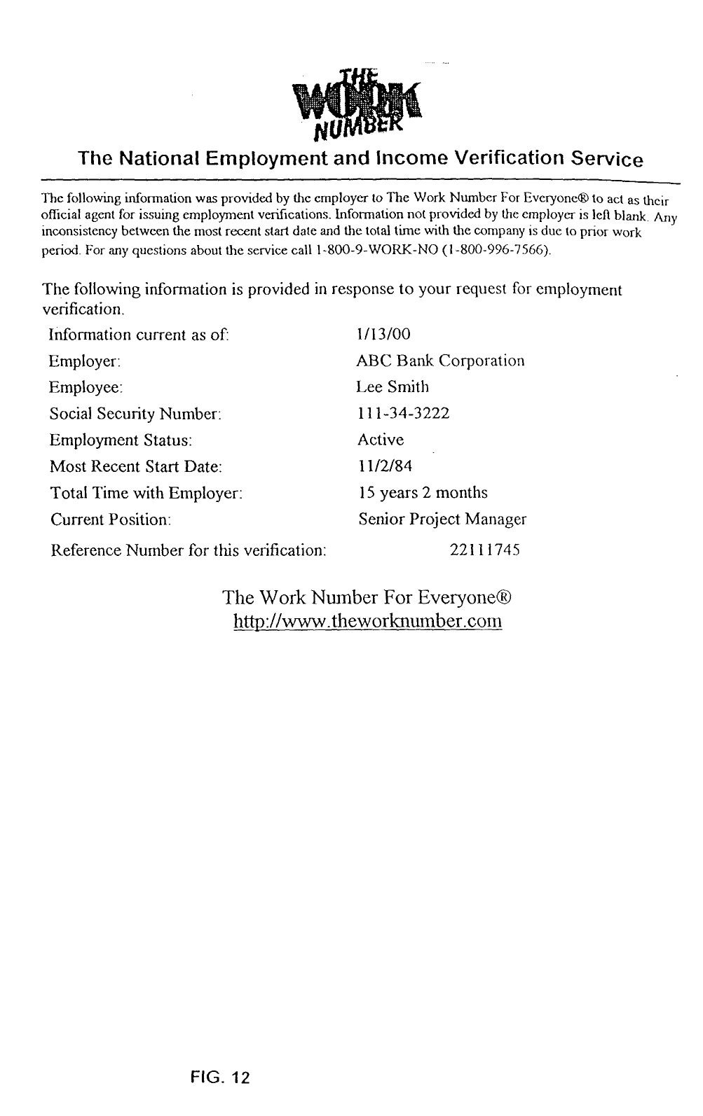

The Basic report currently contains the following employment data: date of verification (supplied by the system), current as of date (date of last data update or employer pay date), employer name, employee name, employee's SSN, employment status (active, inactive, retired, etc.), employee's most recent start date, total time in years and months the employee has been with the employer, current job title, and verification reference number (supplied by the system). A sample of the Basic report is included as FIG. 12. Currently no SKC is required by TALX to obtain a Basic report.

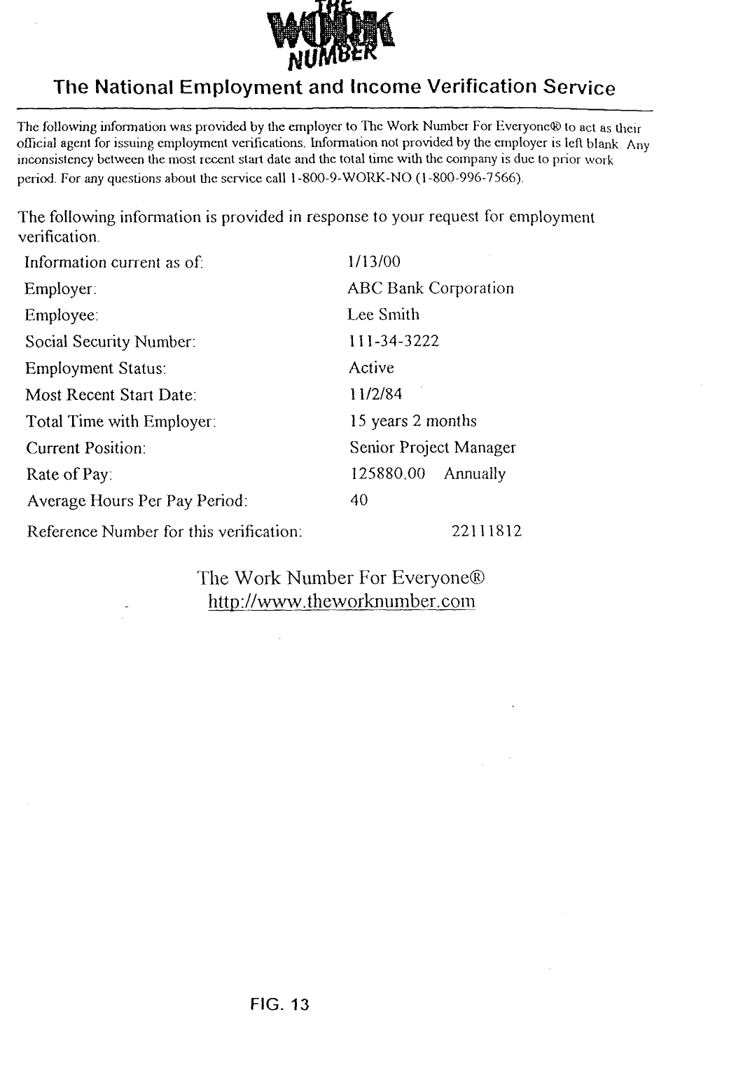

The Basic+ report currently contains the following employment data: date of verification (supplied by the system), current as of date (date of last data update or employer pay date), employer name, employee name, employee's SSN, employment status (active, inactive, retired, etc.), employee's most recent start date, total time in years and months the employee has been with the employer, current job title, employee's rate of pay (hourly, weekly, etc.), average hours worked per pay period, and verification reference number (supplied by the system). A sample of the Basic+ report is included as FIG. 13. A Basic+ report requires the use of a SKC because it contains salary information.

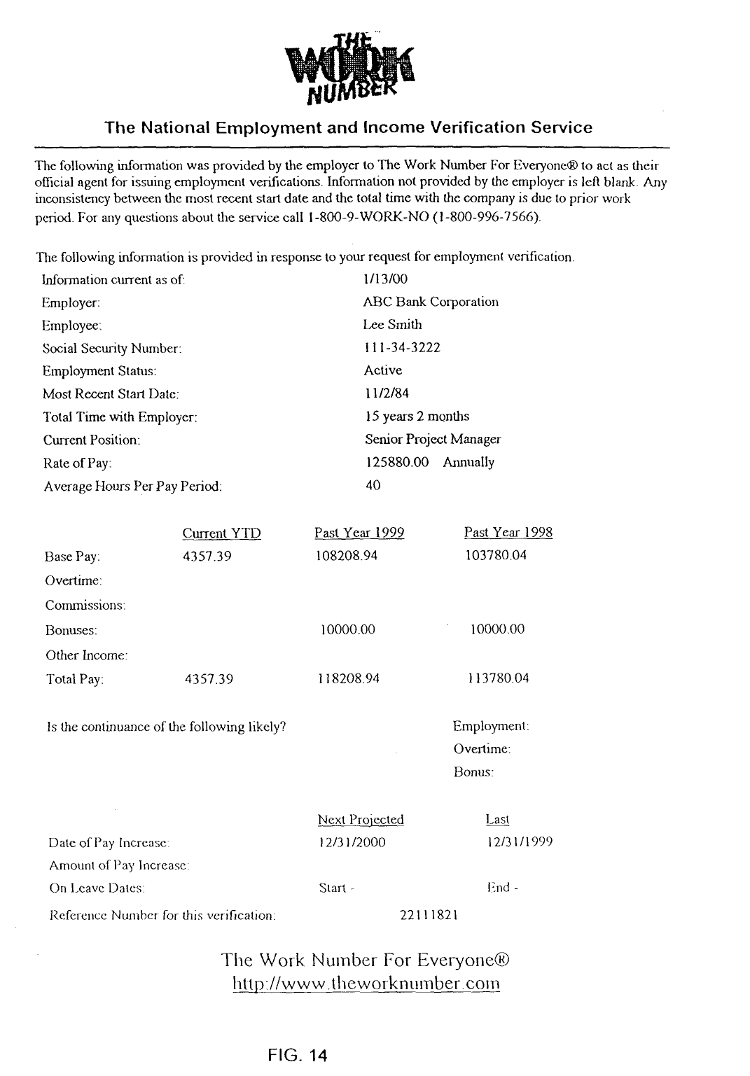

The Full report currently contains the following employment data: date of verification (supplied by the system), current as of date (date of last data update or employer pay date), employer name, employee name, employee's SSN, employment status (active, inactive, retired, etc.), employee's most recent start date, total time in years and months the employee has been with the employer, current job title, employee's rate of pay (hourly, weekly, etc.), average hours worked per pay period, employee's year-to-date pay information, previous years income information, previous two years income information (current, previous, and two years previous income information is broken down at the option of the employer, into the following categories; base pay, overtime pay, bonus, commissions, other pay, and total pay), likelihood of bonus (optional), next projected date of pay increase (optional), last date of pay increase (optional), next projected amount of pay increase (optional), last amount of pay increase (optional), on leave start date (optional), on leave stop date (optional) and verification reference number (supplied by the system). Optional data may or may not be supplied by the employer and is left to their discretion. All optional and required data that is supplied by the employer to the system is in the report. A sample of the Full report is included as FIG. 14. A Full report requires the use of a SKC because it contains salary information.

At the service provider's option, an SKC may or may not be required for access to a particular report. As currently practiced by applicant, the SKC is required for a Full report and a Basic+ report, but is not required for a Basic report or a Public Assistance report. At the employer's option the use of an SKC may be required for a Basic report.

A reference number record is created for each report that is sent to the verifier 16. A billing record is entered in the system database. If an SKC has been used, it is inactivated.

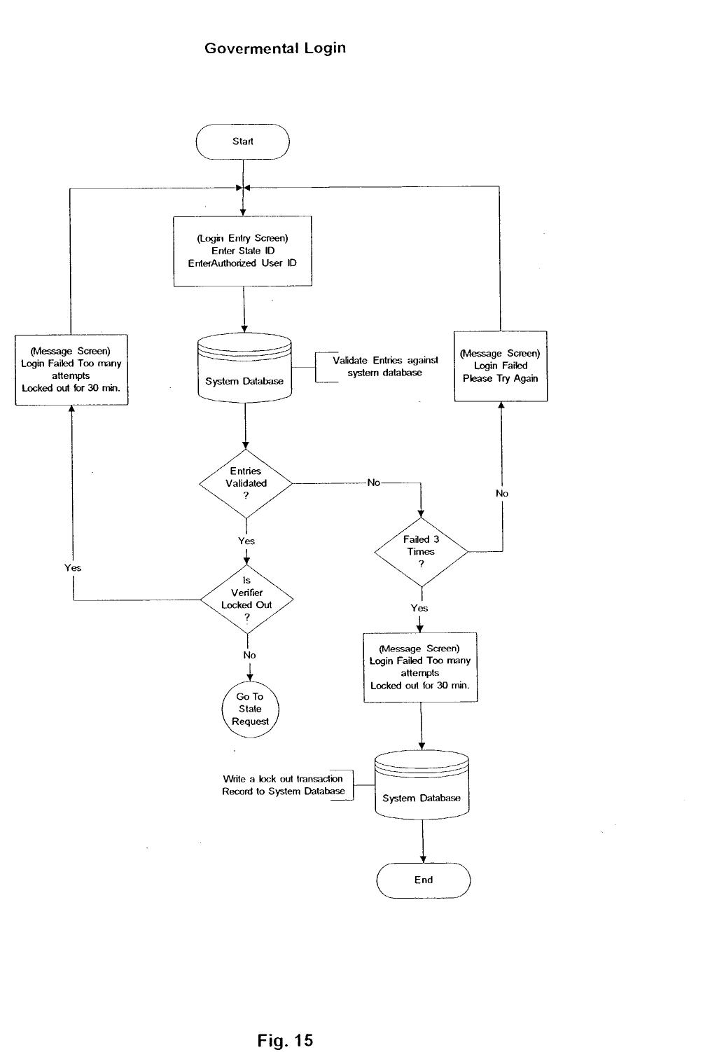

FIG. 15 is a flowchart of the software that is used when a governmental agency logs in for the purpose of determining whether public assistance should be granted. The governmental agency verification process uses a different URL not accessible from the home page of other verifiers. A login screen is presented with various input fields including the State ID number and the authorized user's ID number. The State ID number identifies the state wherein the governmental agency resides and the authorized user's ID number may identify various agencies/users from offices of a State within a given geographical area.

For example, State ID 53 refers toTexas. The user ID 123456 has two components, 123 identifies a specific governmental agency, 456 identifies a person who is an authorized user within the specific governmental agency. The State ID number and the authorized user's ID number entered on the login screen will be compared against valid State ID numbers and valid authorized user ID numbers in the database. If there is a match, another screen will be presented to the user for processing its request. Other types of identification codes unique to an agency/user are within the scope of this invention.

During the governmental agency login process a governmental agency user may make up to three attempts to login. If for whatever reason, i.e., mis-typed State code, forgotten Authorized User ID, etc., login is not achieved the governmental agency user sees a message screen telling him that login was unsuccessful and allows him to attempt login again. If after three attempts the governmental agency user has not sucessfully logged in, the governmental agency user sees a meesage screen telling him that he is locked out of the system for a period of thirty minutes. The web application writes a lock out record for this governmental agency user to the primary database 32 as previously described. Upon the next attempt to login, the system compares the date and time stamps on any lock out records for the governmental agency user to the system date and time. If at least thirty minutes have passed since the lock out record was written, the governmental agency user may again attempt to log into the system. If at least thirty minutes have not passed the governmental agency user sees a lock out message screen and is not allowed to attempt login. This lock out feature enhances governmental agency security by preventing long periods of login attempts for the purpose of trying unlimited combinations of ID information, either manually or via a software program, to discover a valid combination of State ID and authorized user ID and to surreptiticiously gain system access. Other types of lock out methodology unique to each service provider are within the scope of this invention.

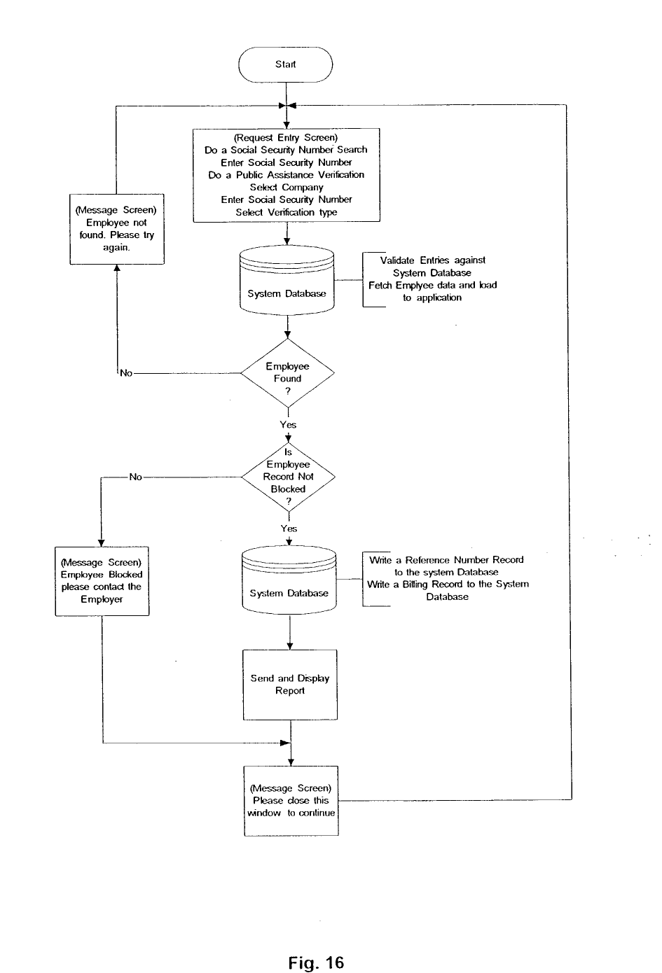

FIG. 16 is a flowchart of the system software for a governmental agency request for a verification. The user selects the applicants employer 10 from a drop down menu that displays a list of employers 10. The user then enters the public assistance applicant's SSN. If the information selected and entered is validated against corresponding information in the service provider 14 primary database 32, a governmental report will be generated.

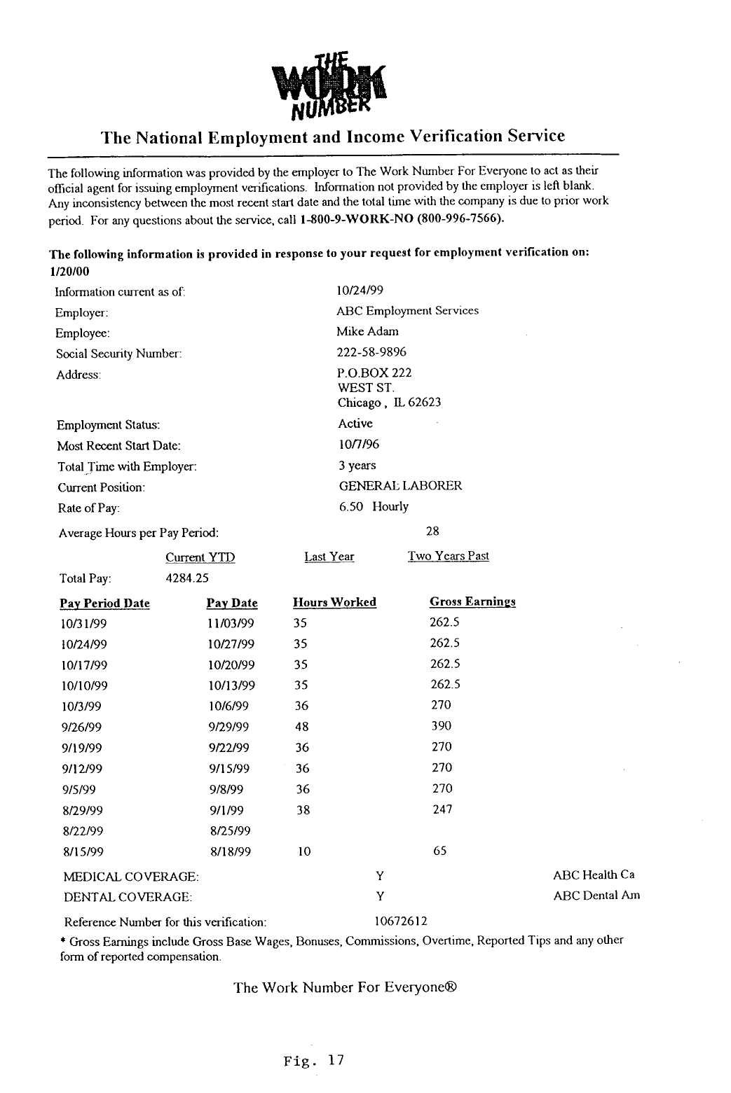

The public assistance report contains the following employment data: date of verification (supplied by the system), current as of date (date of last data update or employer pay date), employer name, employee name, employee's address (optional), employee's SSN, employment status (active, inactive, retired, etc.), employee's most recent start date, total time in years and months that the employee has been with the employer, current job title, employee's rate of pay (hourly, weekly, etc.), average hours worked per pay period, totay pay for current year, total pay for previous year, total pay for previous second year, twelve pay periods of pay period ending dates, pay dates, hours worked and gross earnings, medical insurance coverage (yes/no, optional), medical insurance carrier (optional), dental insurance coverage (yes/no, optional), dental insurance carrier (optional), and verification reference number (supplied by the system). Public assistance verifications are only available to governmental agencies, not the general verifying community. A sample public assistance report is included as FIG. 17. Other public assistance reports with different types of employment data are also within the scope of this invention. This public assistance report is therefore merely an example and not a limitation on the invention.

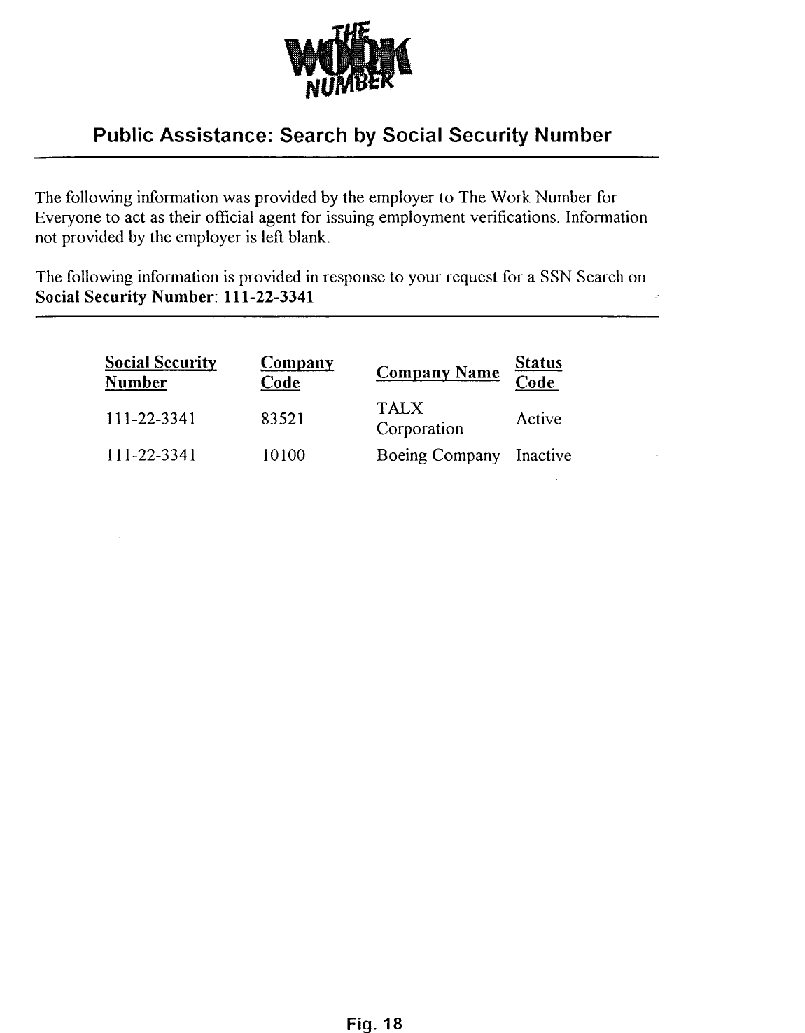

Social Security Search is a system function that lists all incidents of an employee's SSN on the system and is composed of, date of request, employee's 12 SSN, companies 10 that the SSN was found under, and employment status for each company. The SSN search function is only available to governmental agencies, not the general verifying 16 community. A sample of the Social Security Search report is included as FIG. 18.

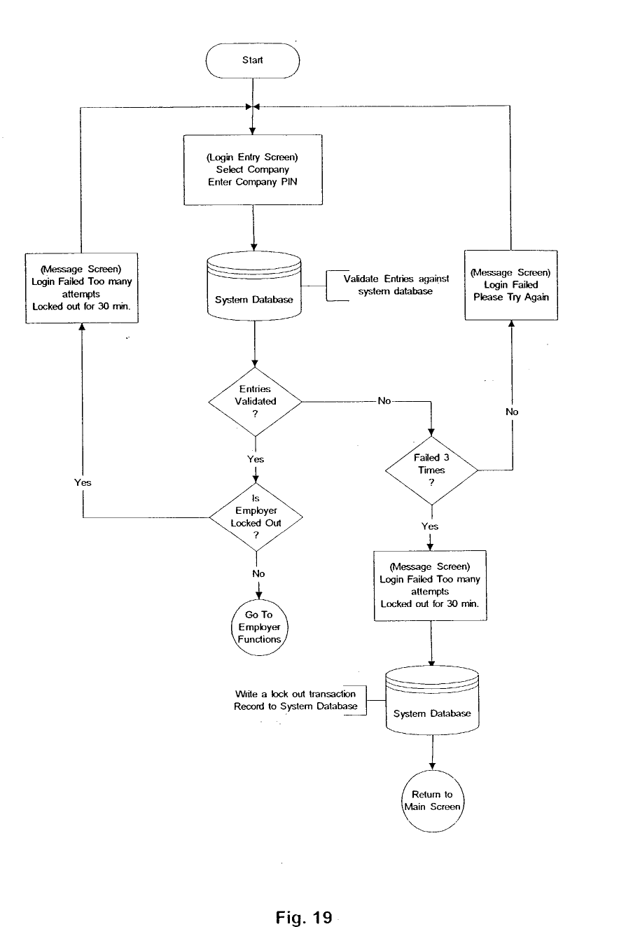

FIG. 19 is a flowchart explaining how the system software allows the employer 10 to gain access to the system for a specific function including blocking or unblocking a particular employee's 12 records, making changes to employee's 12 status to activate or inactivate the employee, to enter new term date information for the employee 12 and to update employee 12 records. A login entry screen is presented to the employer 10 with a drop-down menu containing a list of all employers 10. The employer 10 selects their company. The login screen displays a single input field for a company personal identification number (PIN). The system will compare the selected company's company code and the entered company PIN with valid company codes and valid company PINs in the system database. If there is a match, another screen will be presented for the various employer 10 functions. During the employer 10 login process an employer 10 may make up to three attempts to login.

If for whatever reason, i.e., mis-typed company PIN, forgotten company PIN, etc., login is unsuccessful, the employer 10 sees a message screen telling them that login was unsucessful and allows them to attempt to login. If after three attempts the employer 10 has not sucessfully logged in, the employer 10 sees a message screen telling them that they are locked out of the system for a period of thirty minutes. The web application writes a lock out record for this employer 10 to the primary database 32 as previously described. Upon the next attempt to login, the system compares the date and time stamps on any lock out records for the employer 10 to the system date and time. If at least thirty minutes have passed since the lock out record was written, the employer 10 may again attempt to log into the system. If at least thirty minutes have not passed the employer 10 sees a lock out message screen and is not allowed to attempt login. This lock out feature enhances employer 10 security by preventing long periods of login attempts for the purpose of trying unlimited combinations of ID information, either manually or via a software program, to discover valid combinations of employer ID information and surreptitiously gain system access. Other types of lock out methodology known to those skilled in the art are within the scope of this invention.

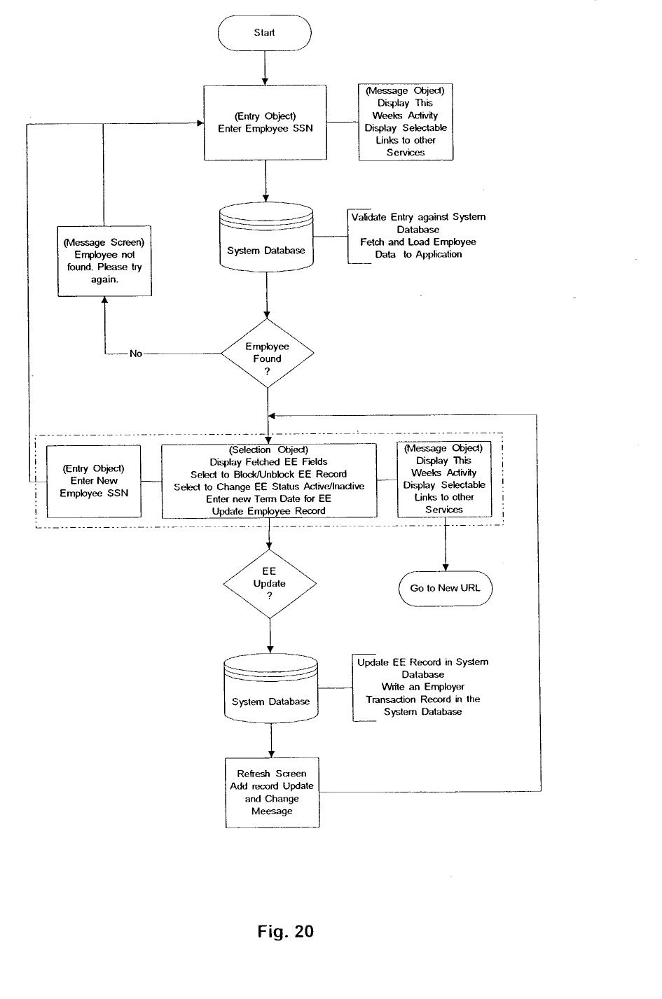

FIG. 20 is a flowchart for the software for the various employer 10 functions. The various input fields are displayed on the input screen for the employer's 10 use. The employer 10 may select to block or unblock data for a particular employee 12 at the employee's 12 request. If an employee 12 is no longer employed during a pay cycle, the employer 10 can change the employee's 12 status from active to inactive and vice versa. A new employment end date may also be entered and the employee's 12 information updated.

Record blocking refers to the system function that will allow subscribing employers 10 to make any employee 12 record inaccessible for whatever reason. For legal reasons, an employer 10 may block an employee 12 record at any time. Any employee 12 record blocks placed by the employer 10 will remain in place until removed by the employer 10. Record blocks are under the sole control and discretion of the employer 10 and the employee 12.

Termination date change refers to the system function that will allow employers 10 to change an employee's 12 termination date. Employers 10 may change a termination date on any employee 12 at any time. The use of this system function insures that employees 12 suddenly terminated or with termination dates reported incorrectly can be maintained outside of the normal payroll cycle data update.

Status Code Change refers to the system function which will allow subscribing employers 10 to change an employee's 12 status code. The system supports a number of status codes that function to disclose an employee's 12 employment status; active, inactive, on leave, part-time, as needed, etc. Employers 10 may change the status code of an employee 12 at any time. The use of this system function insures that employees 12 with changes to their employment status can be maintained outside of the normal payroll cycle data update, i.e., an employee 12 has a system status code indicating that he/she is actively employed at the time of the last employer's 10 data download. If prior to the next data load, the employee 12 resigns, is laid off, etc., the employer 10 may access the system and change the employee's 12 status code to one that properly indicates that the employee 12 is no longer actively employed by employer 10.

At the completion of any of the employer 10 functions listed above a transaction record and employee 12 data update is written to the primary database 32.

Reference number refers to a unique identifying number that the system assigns to every verification performed by the system. The reference number may be used by a verifier 16 to audit the validity of a verification at some future date. At the time that a reference number is assigned by the system, the current data provided for that verification is retained in toto in primary database 32. By accessing the system via the Internet 20, a verifier 16 may request an audit by reference number verification. The verification received will be an exact duplicate of the original verification. Use of audit by reference number is generally by a party not directly involved in the original verification.

For example, AJAX Mortgage wishes to sell a loan to a secondary market, the purchaser of that loan wants to verify that the loan was made appropriately, following accepted guidelines, and that no collusion with the borrower has occurred. The purchaser of the loan may access the system via the Internet 20 and request verification based on the reference number. Comparison of the audit by reference number verification to the original verification will reveal that the verification used as part of the underwriting criteria for making the loan is indeed valid and has not been modified or changed, thus preventing fraud.

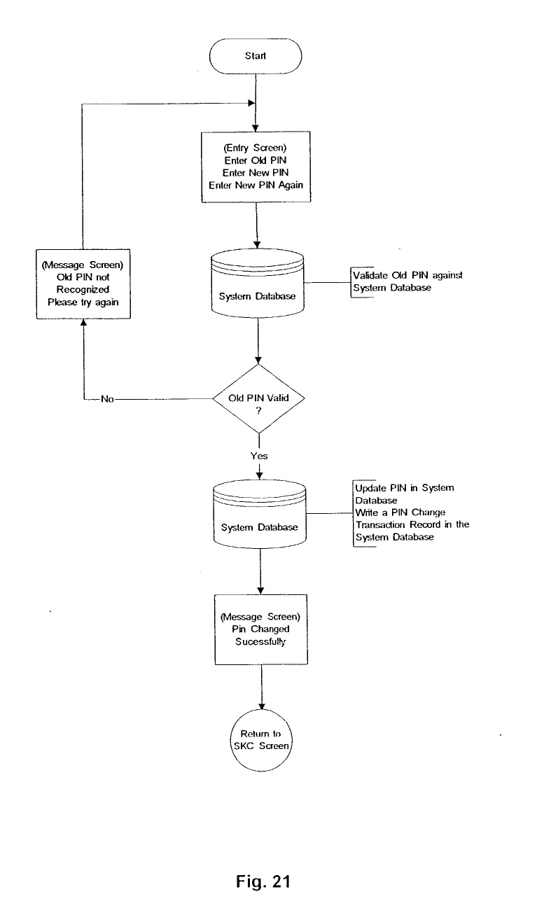

FIG. 21 is a flowchart for the system software whereby an employee 12 can update or change their PIN in the database. An entry screen is presented to the employee 12 with various input fields, including a field to enter an old PIN and a new PIN. Upon entering the old PIN, the new PIN, and re-typing the new PIN to confirm it, the old PIN entered is validated against existing PINs in the database. If the old PIN is correct and the new PIN matches the re-typed new PIN, the employee 12 sees a message screen that their PIN has been successfully changed, and the employee PIN record in the primary datase 32 is updated. For security reasons, PIN entries are never displayed as the numbers entered, but rather appear as stars. This method of allowing PIN changes and not displaying entries is well known to those skilled in the Art.

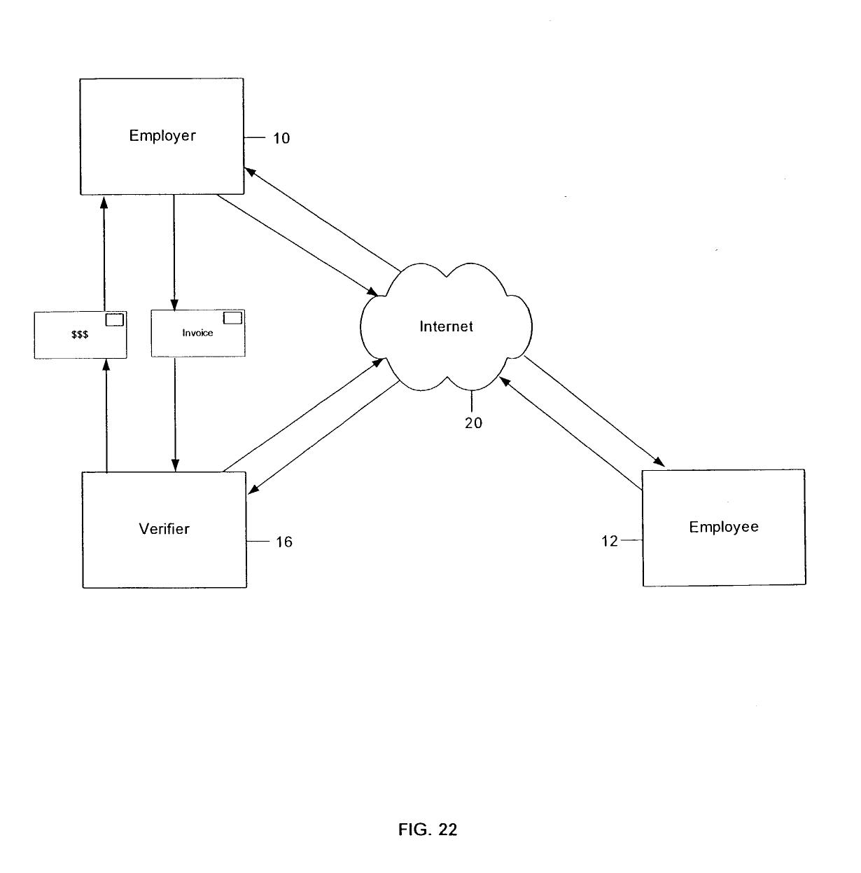

FIG. 22 is a block diagram of an alternative embodiment of this invention. This block diagram differs from the diagram in FIG. 1 because the duties and functions of the service provider 14 have been subsumed by the employer 10. In this alternative embodiment, the database servers are maintained by or for the employer 10 and the employer 10 may or may not charge for reports generated. This alternative embodiment provides a system to an employer 10 that wishes to keep the traditional verification process in-house, or at least partially in-house.

In this alternative system, the employer 10 loads the employment data directly on to the employer's database servers 110 and 112 and updates them on a periodic basis in the same fashion as it would if this employment data was being transferred to the database servers 32 and 34 of the service provider 14. However, in this alternative embodiment, the database servers 110 and 112 are located at the employer's 10 place of business or are maintained by a third party on behalf of the employer 10. If required, the employee 12 accesses the database servers 110 and 112 for assignment of an SKC, if an SKC must be disclosed to the verifier 16. The verifier 16 accesses the employer 10 databases 110 and 112 and upon entry of valid identification codes and a valid SKC, if required, will receive a report as requested. If a fee is charged by the employer 10, it is paid by the verifier 16. In this alternative embodiment, the connections made between the employee 12, verifier 16 and employer 10 may or may not utilize SSL technology for encryption. Other types of encryption methods known to those skilled in the art are within the scope of this invention.

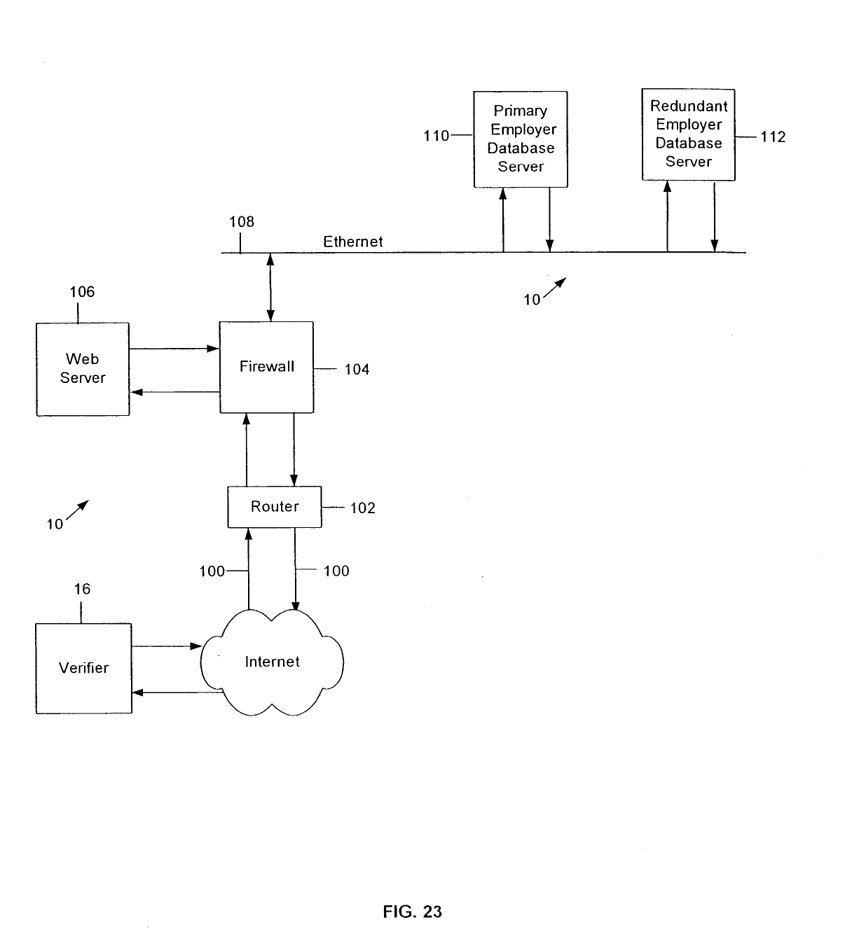

FIG. 23 is a block diagram showing the Internet 20 connection between the verifier 16 and the employer's 10 primary database server 110 and redundant database server 112. The verifier 16 enters the URL for the employer's 10 web site and establishes a connection over the Internet 20. The employer 10 is connected via pipes 100, for example, T1 lines, to the employer's router 102. The inquiry from the verifier 16 then moves from the router 102 to the firewall 104, to the web server 106, back to the firewall 104, to the ethernet 108, to the employer's primary database server 110 and redundant database server 112. If the identification codes and the SKC are validated by the employer 10 database server 110, a report will be generated for the verifier 16. The report moves from the ethernet 108 to the firewall 104 to the web server 106, back to the firewall 104 and through the router 102 as indicated by the arrows in the drawing. The report then moves through the pipes 100 to the Internet 20 and back to the verifier 16. In this alternative embodiment, the connections made between the employee 12, verifier 16 and employer 10 may or may not utilize SSL technology for encryption. Other types of encryption methods unique to each employer 10 are within the scope of this invention.

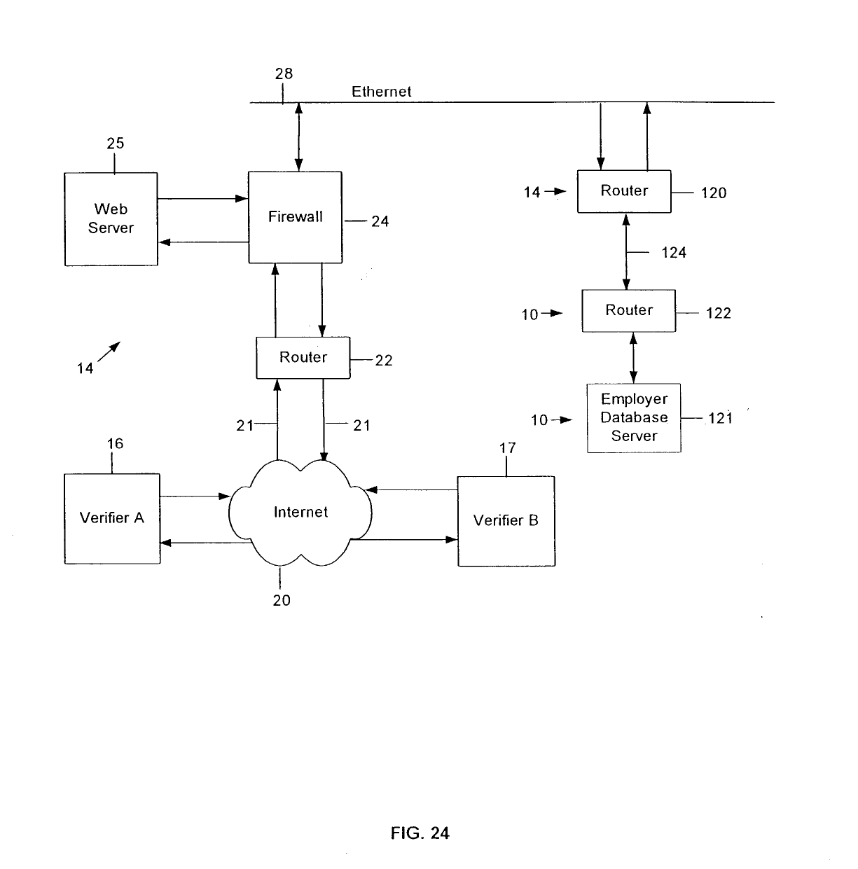

FIG. 24 is an alternative embodiment of the verification system of FIG. 5. In FIG. 5, multiple verifiers 16,17 simultaneously access the service provider 14 over the Internet 20 and upon authorization, reports from multiple employers 10 are sent back over the Internet 20 to the verifiers 16, 17. In FIG. 5, the primary database server 32 and the redundant database server 34 are located at the service provider's place of business or they are maintained offsite under the servicer provider's 14 control. In the alternative embodiment of FIG. 24, the primary database server 121 is located at the employer's 10 place of business or offsite under the employer's 10 control. This alternative configuration is attractive to employers 10 that do not wish to relinquish control of their employment data to a third party, i.e., the service provider 14.

In the alternative embodiment of FIG. 24, the verifiers 16, 17 enter the URL for the service provider 14, previously described. A properly authorized request is sent over ethernet 28 to a router 22 which accesses the employer 10 database 121 over a connection, for example, a leased telephone line 124. The employment data for a report is sent from the employer database 121 over leased line 124, through router 120 across ethernet 28 to firewall 24 to the service provider web server 25 where a report, previously described, is generated and sent back to the firewall 24, through router 22 and connection 21 to the Internet 20 and finally to the verifiers 16, 17. In this alternative embodiment the connections made between the employee 12, verifier 16, service provider 14 and employer 10 may or may not utilize SSL technology for encryption. Other types of encryption methods known to those skilled in the art are within the scope of this invention.

The service provider 14 typically will have the followig hardware/software at its place of business: router 22, firewall 24, web server 25, ethernet 28 and router 120. The employer 10 will have the following hardware/software at its place of business: router 122 and employer database server 121.

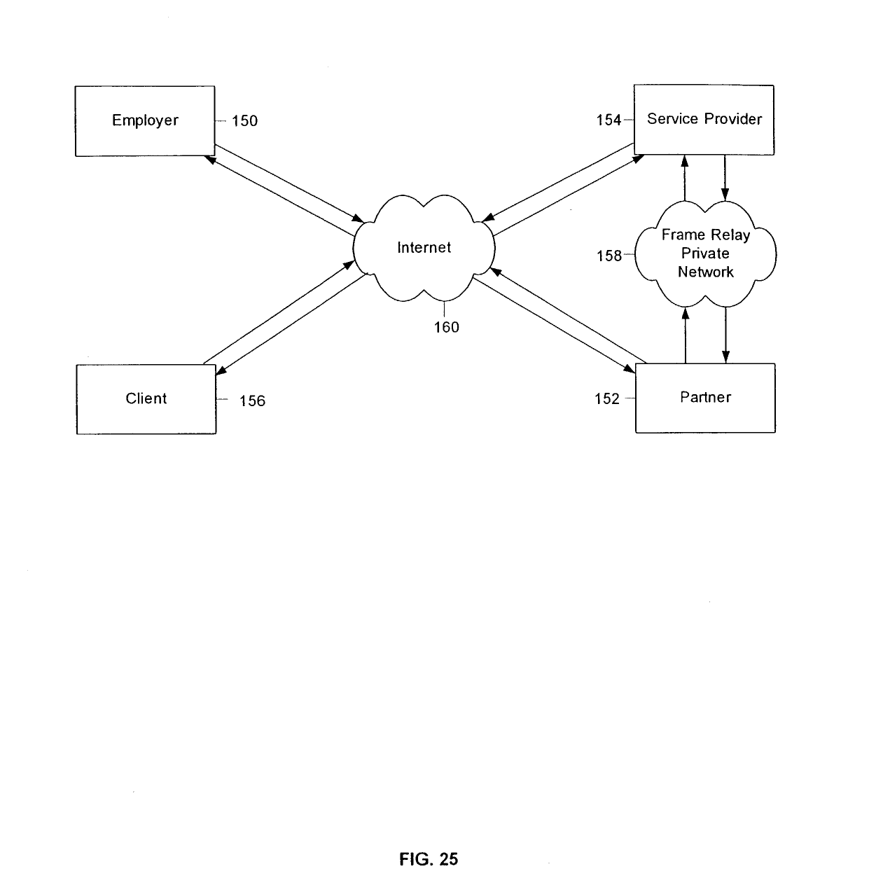

FIG. 25 is a block diagram of a system called Confirmation Express. The diagram describes the relationship between a variety of parties and their computer systems including the relationship between the employer 150, the employee, the partner 152, the service provider 154 and the Client 156. The Confirmation Express system utilizes the hardware and operating system software previously described in this specification concerning The Work Number. The arrows in FIG. 25 indicate the exchange of data between the parties over the Internet 160 and the Frame Relay connection 158. The employer 150 transmits employment data over the Internet 160 to the service provider 154. In the preferred embodiment, the employer 150 encrypts the data before it is sent to the service provider 154. The Confirmation Express system does not require the use of a Salary Key Code, does not require direct interaction with the system by the employee, and is therefore more user friendly than The Work Number.

The employee fills out a credit application and gives it to the client 156. The credit application requires disclosure of the name of the employer 150, the employee's SSN and other financial information. The client 156 then contacts the partner 152 over the Internet 160, inputting the employee identification data and confirmatation request to the partners 152 internet server. The user interface between the client 156 and the partner 152 is the resposibility of the partner 152 to provide and will not discussed here. The partners 152 XML electronic interface then builds and routes the request via Frame Relay 158 to the service provider 154. The Service Providers 154 XML electronic interface then parses the confirmation request and compares partner 152 and client 156 identification data to valid identification data to determine if the client 156 should receive a report containing employment data from the service provider 154. If the client 156 can demonstrate proper authority by inputting valid identification data, the service provider 154 generates an XML data stream response via electronic interface and returns it via the Frame Relay connection 158 to the partner 152. The partner 152 receives the response, processes it, and routes it via the internet 160 to the client 156. The client 156 will typically print a hard copy of the report on a printer at their office for inclusion in the employee's loan application file.

Although it is less efficient, the employer 150 may also transmit data to the service provider 154 via magnetic tapes, or over the telephone lines via a modem 176. In the preferred embodiment, transmission of employee data occurs over the Internet 160. In the preferred embodiment, the transaction between the client 156 and the partner 152 occurs over the Internet 160 and the XML transaction between the partner 152 and the service provider 154 occurs via Frame Relay 158.

The client 156 is charged a transaction fee for each report prepared by the partner 152 and service provider 154. The partner 152 keeps accurate records of all transactions and is responsible for monthly invoicing of the client 156, or any other method of collection as deemed appropriate by the partner 152. The service provider 154 also keeps accurate transaction records and revenue for each transaction is shared as defined in the partnership agreement between the partner 152 and service provider 154.

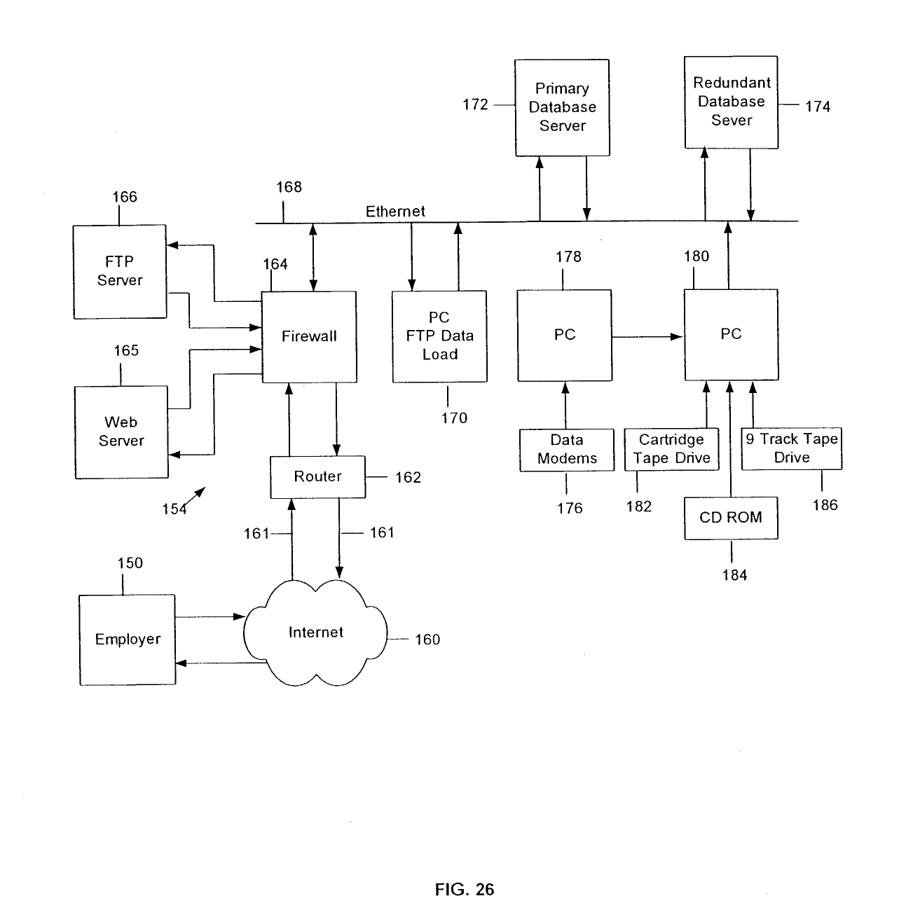

FIG. 26 is a block diagram showing the connection between the employer 150 and the service provider 154 over the Internet 160 when the employer 150 transfers employment data to the service provider 154 computer system. The employer 150 establishes a connection in conventional fashion with the Internet 160 in order to connect with the service provider 154. The service provider 154 is connected to the Internet 160 by pipes 161 which could be T1 lines or other types of connections. The pipes 161 connect to a router 162. Applicant has found that a Cisco 3620 router is suitable for this purpose. These routers are available from Cisco Systems of Santa Clara, Calif. The data is then transferred from the router 162 through a firewall 164. Applicant has found that a Sun Solaris server is suitable to be used as the firewall 164, running a Sun 0S 5.6 operating system with McAffee anitivirus protection and Check Point Firewall software. The Sun Solaris Server is available from Sun Microsystems of Palo Alto, Calif. The McAfee software is available from Network Associates of Santa Clara, Calif. The Check Point Firewall software is avilable from Check Point Software Technologies of Redwood City, Calif. The data moves through the firewall 164 to the File Transfer Protocol (FTP) server 166. Applicant has found that the following hardware and software are suitable for the FTP server 166: Intel ALT server available from Intel Corporation of Santa Clara, Calif.; and Redhat Linux 6.0 operating system available from Redhat of Durham, N.C. The data is temporarily stored in the FTP Server in a user name, password protected directory. Each employer 150 utilizing this preferred method of data transfer is assigned such an account.

When the data is retrieved from FTP server 166 in prepartion for loading to primary database server 172, the data then goes back through the firewall 164 to the ethernet 168. Other types of networks could also be suitable including a token-ring. Various types of network topologies are well known to those skilled in the art and are within the scope of this invention. The data passes across ethernet 168 to a workstation 170 for loading of the FTP data. Applicant has found that the following hardware and software are suitable for the workstation 170: a Portland personal computer (“PC”) available from Intel Corporation of Santa Clara, Calif.; running Microsoft Windows NT 4.0 operating system available from Microsoft Corporation of Redmond, Wash. Additionally workstation 170 has the following software installed to be run as required: PGP Encryption/Decryption software available from Network Associates of Santa Clara, Calif.; PKZip data compression software available from PKWARE Incorporated of Brown Deer, Wis. and IBM Compress data encryption decryption software available from IBM of Armond, N.Y. In preparation for loading, data is decrypted using appropriate software discussed above. The data then moves along the ethernet 168 to the primary database server 172 and is copied to redundant database server 174. Anytime data is stored in primary datase server 172 it is also copied to redundant database server 174. Applicant has found that a Compaq Proliant 7000 server running MS Windows NT 4.0 as an operating system and the Oracle 8.05 database system works well for this purpose. The Proliant servers can be obtained from Compaq Computers of Houston, Tex. The MS Windows NT can be obtained from Microsoft of Redmond, Wash. and the Oracle software can be obtained from Oracle of Redwood Shores, Calif. A redundant database server 174 also connects to the ethernet 168 in case of any problems with the primary database server 172. The same hardware and software used for the primary database server 172 also work well for the redundant database server 174.

In review, employment data from the employer 150 is routed over the Internet 160. The data arrives at the service provider 154 and is transmitted via pipes 161 to router 162. The data then moves from the router 162 to the firewall 164 and into the FTP server 166. The data then moves back through the firewall 164 to the ethernet 168 to workstation 170 where it is then prepared for loading. The data then moves back over the ethernet 168 to the primary database server 172 and the redundant database server 174 where it is stored.

Although not as efficient as loading data over the Internet 160, the employer 150 can also load data over the telephone lines via the data modem 176 where it is received by workstation 178. Data received is temporarliy stored in a user named, password protected directory. Applicant has found that U.S. Robotic 28.8 modems are suitable for this application. The modems can be obtained from 3-Com Corporation of Santa Clara, Calif. Applicant has determined that the following hardware and software are suitable for the workstation 178: an Intel Portland PC with Microsoft Windows NT 4.0 operating System, PGP software for data encryption, IBM Compress software for data encryption and compression, PK Zip for data compression, Hyper Access 5.0 modem control software and McAffee Virus for virus protection. These products can be obtained from the following vendors: Intel Portland PC from Intel Corporation of Sata Clara, Calif., Hyper Access 5 modem control software from Hillgraeve of Monroe, Mich., PGP 6.5 encryption software available from Network Associates of Santa Clara, Calif.; IBM compress software available from IBM of Armond, N.Y.; PKZIP available from PKWARE Incorporated Brown Deer, Wis., and McAffee Anti-virus 4.0.4, available from Network Associates of Santa Clara, Calif. Employer 150 data is uncompressed or decrypted as appropriate, scanned for viruses, prepared for loading, and moved across a dedicated link through workstation 180 across the ethernet 168 to primary datbase server 172 and redundant database server 174 where the data is stored. A dedicated link to workstation 180 is used to insure that access to TALX internal networks is not possible via modem and completly under the control of the firewall 164.

Applicant has determined that the following hardware and software are suitable for the workstation 180: an Intel Portland PC available form Intel Corporation of Sata Clara, Calif. running MS Windows NT 4.0 operating system available from Microsoft Corporation of Remond, Wash.

In review, data from the employer 150 can be transmitted through the data modem 176 which is then prepared for loading at the workstation 178 and transmitted through the workstation 180 through the ethernet 168 and is thereafter stored on the primary database server 172 and the redundant database server 174.

In the alternative, the employer 150 can also supply employment data through 9 track magnetic tape via tape drive 186. Applicant has found that the following equipment is suitable for tape drive 186: Qualstar 3412S 9-track tape drive, available from Qualstar Corporation of Canoga Park, Calif. with PC workstation 40 running Nova Xchange 2.00 software from Novastar Corporation of Simi Valley, Calif. In another alternative, the employer 150 can supply employment data through cartridge magnetic tape via multi cartridge tape drive 182. Applicant has found that the Xcerta VDS MS-843 EWS-XL multi-cartridge magnetic tape unit available from Comco Incorporated of Bettendorf, Iowa with PC workstation 180 running Nova Xchange 2.00 software from Novastar Corporation of Simi Valley, Calif. is suitable for this purpose. In another alternative the employer 150 can supply employment data on CD ROM via CD ROM drive 184. Applicant has found that the following equipment is suitable for the CD ROM 184: Sony 8× CD from Sony Electronics, Inc. of Park Ridge, N.J.

Suitable backup systems for the primary database server 172 and redundant database server 174, known to those skilled in the art, are also used in this system but are not shown in the drawings.

In review, data loaded on the 9-track tape drive 186 is prepared for loading at workstation 180, is transmitted over the ethernet 168 and stored in the primary database server 172 and the secondary database server 174. Likewise, data loaded by the CD ROM 184 and the cartridge tape drive 182 is prepared for loading by the PC workstation 180 and is transmitted via the ethernet 168 to primary database server 172 and redundant database server 174. Other types of data transfer methods that may be used to transfer data from the employer 150 to the service provider 154, are within the scope of this invention, and are known to those skilled in the art.

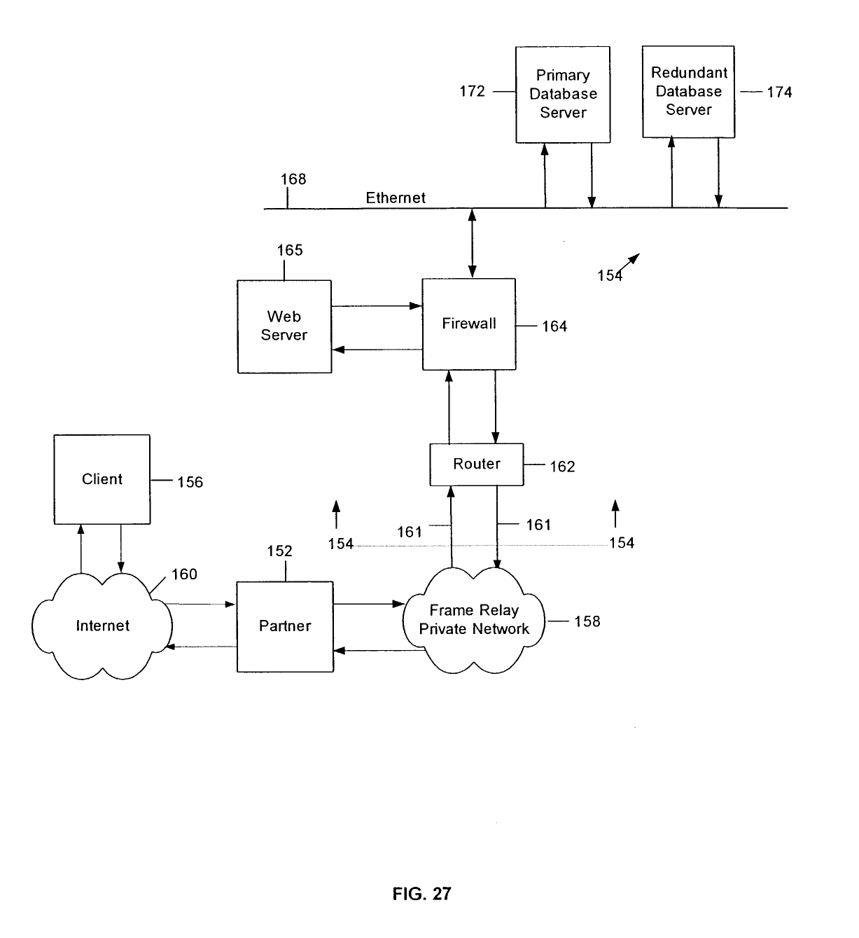

FIG. 27 is a block diagram showing the connection between the client 156, the partner 152 and the service provider 154 over the Internet 160 and Frame Relay 158 when a request for employment and salary confirmation is generated by the client 156.

In the best mode, an employee makes application for a loan at a clients location. The client gains access to the Internet 160, and enters the domain name (Uniform Resource Locator) for the partners 152 web site. The partners 152 elctronic interface receives the request, processes it, generates an appropriate XML request, and makes access to the service provider 154 via Frame Relay 158. The partner may implement XML with a number of readily available software products but applicant has found MS Developer Environment 6.0 using MS Visual J++ 6.0 and MS Interdev 6.0 available from Microsoft Corporation of Redmond, Wash. To work well for this purpose. Data from pipes 161, moves through the router 162 into the firewall 164 and into the web server 165. Applicant has successfully used the following hardware and software for the web server 25: Intel Madronna server available from Intel Corporation of Santa Clara, Calif. running Microsoft Windows NT 4.0 operating system and Microsoft Internet Information Server 4.0 (IIS) web application engine.

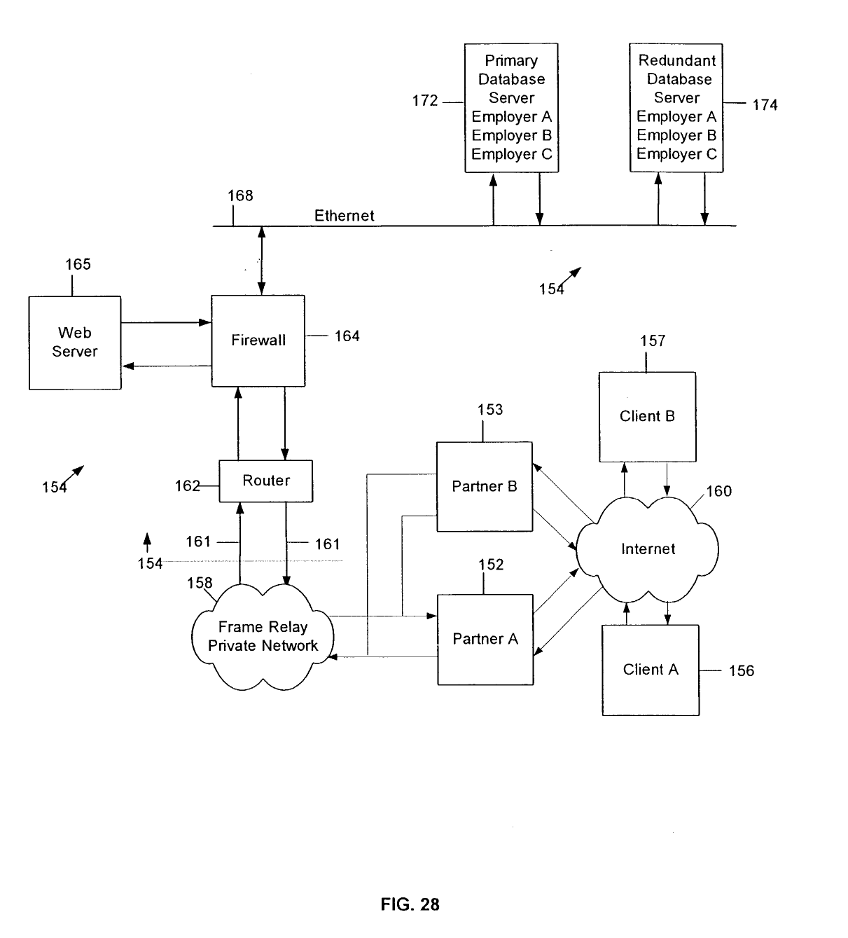

When an appropriate request for employment and salary confirmation is received, the electronic interface accesses the Primary database 172 via ethernet 168 and validates partner 152 ID information contained in the XML request. When partner 152 ID is validated then the server 165 electronic interace passes disclosed salary information from the XML request to primary database 172 and the primary server 172 Oracle program annualizes the salary and produces a Yes/No or no calculation response and returns it to Web Server 165 electronic interface interface via ethernet 168. Upon receipt of the Oracle response from primary server 172 the Web server 165 then fetches basic employment data from primary database server 172 via ethernet 168. Upon receipt of basic employment data from primary server 172 the Web Server 165 electronic interface builds an XML response to the received XML request and sends it thru firewall 164 to router 162. Router 162 sends the response via Frame Relay 158 to partner server 152. Partner server 152 processes the response for display and returns it to verifer 156 via internet 160. In review, the client 156 makes a salary and employment confirmation request to the partner server 152 electronic interface. The partners server 152 electronic interface processes the request and sends an XML request to service providers 154 web server 165 via Frame Relay 158. Upon validation of the appropriate ID information contained in the XML request, the sevice provider 154 processes the request and returns an XML response to the partner 152 server via Frame Relay 158. The partner 152 then processes the response and returns it to the client 156 via the internet 160. FIG. 28 is a block diagram of the confirmation process in best mode as currently known to applicant. Multiple partners with multiple clients enter into agreements with the service provider 154 and are able to access the confirmation system via Frame relay 158 simultaneously. In FIG. 28 multiple partners and clients are shown, i.e. client A, identified by numeral 156, client B identified, identified by numeral 157, partner A, identified by numeral 152 and partner B idientified by numeral 153.

Likewise, multiple employers 150 enter into agreements with the service provider 154 and employment data from each employer 150 is stored on primary database server 172 and copied to redundant database server 174 at the service provider's 154 place of business. Today hundreds of employers 150 have entered into such agreements to use this verification system over the Internet 160. Employment data for millions of employees 157 from various employers 150 is securely stored on primary database server 172 and redundant database server 174 at the service provider's 154 place of business.

When each partner 152 enters into an agreement with service provider 154 they are assigned a partner ID. When each client 156 enters into an agreement with a partner 152, the service provider 154 approves each such agreement, and registers the clients 156 partner sub-account code or some other form of identification. The partners 152 partner ID and the clients 156 sub-account code act as a user name password, so the client 156 can can request confirmation serves via the partner 152 electronic interface from service provider 154. For example, ABC Company has entered into an agreement with service provider 154. ABC Company could be assigned a partner ID code of 12345678. Like wise CDE Company has entered into an agreement with ABC Company which is a partner of service provider 154 and service provider 154 has approved the agreement. ABC Company would provide the clients sub-account code, or other form of identification to service provider 154 for registration in the service providers 154 database. Each office or location of CDE Company could have a unique sub-account code or other form of identification. For example, CDE Company has an office in Arlington, Va., with a sub-account code of 91011. When requesting confirmation service via the partner 152 the XML request string would contain the partners 152 partner ID and the client 156 sub-account code. Upon receipt of a confirmation request from partners 152 electronic interface the partner ID and the clients sub-account code are validated before the request is processed. The service provider 154 compares these ID codes against valid ID codes stored in the primary database server 172 and validate whether the client 156 has proper access to the system. These ID codes identify that the inquiry for confirmation of employment information is being made by a known and authorized client 156 and a known via a known and authorized partner 152. Other types of identification codes are within the scope of this invention.

These partner Ids and client Ids facilitate proper billing by the partner 152 of the client 156 and proper reporting of transactions by service provider 154. A fee is charged to the client 156 by the partner 152 for each transactions. Service provider 154 shares in those fees as defined in the agreement between the partner 152 and service provider 154. In the best embodiment, all billing and collection for transactions for confirmation services are the responsibility of the partner 152, other methods of billings and collection are within the scope of this application. On a schedule defined by the agreement between the service provider 154 and partner 152 transactional reporting between the service provider 154 and partner 152 are reconciled for the purpose of sharing revenue properly. A unique transaction ID, known as a reference number, is assigned to each confirmation response to facilitate proper reporting and billing as well as serve as an audit tool should questions arise from the employee, parnter 152, and/or service provider 154 in the future.

In the best mode, multiple employers 150 enter into contracts with the service provider 154 so a plurality of employees 157 can take advantage of this confirmation system. FIG. 28 is a block diagram similar to FIG. 27 except that the service provider 154 is storing data for multiple employers A, B, and C with thousands of employees 157 and is handling requests from multiple clients 156,157 via multiple parteners 152, 153 simultaneously. The Confirmation eXpress system that is presently in use at TALX Corporation uses the model shown in FIG. 28. This makes the system more cost-efficient and attractive from the perspective of the service provider 154.

This invention is currently practiced using Extensible Markup Language (XML) interface technology well known to those skilled in the art. In the alternative, it may also be practiced by the process of HTML, downloading Java Script Code to the users (i.e. partner 150, client 156 or employer 150). In yet another way, the invention may be practiced by down loading Active X code to the users. Both Java Script and Active X are well known to those skilled in the art and are within the scope of this invention.

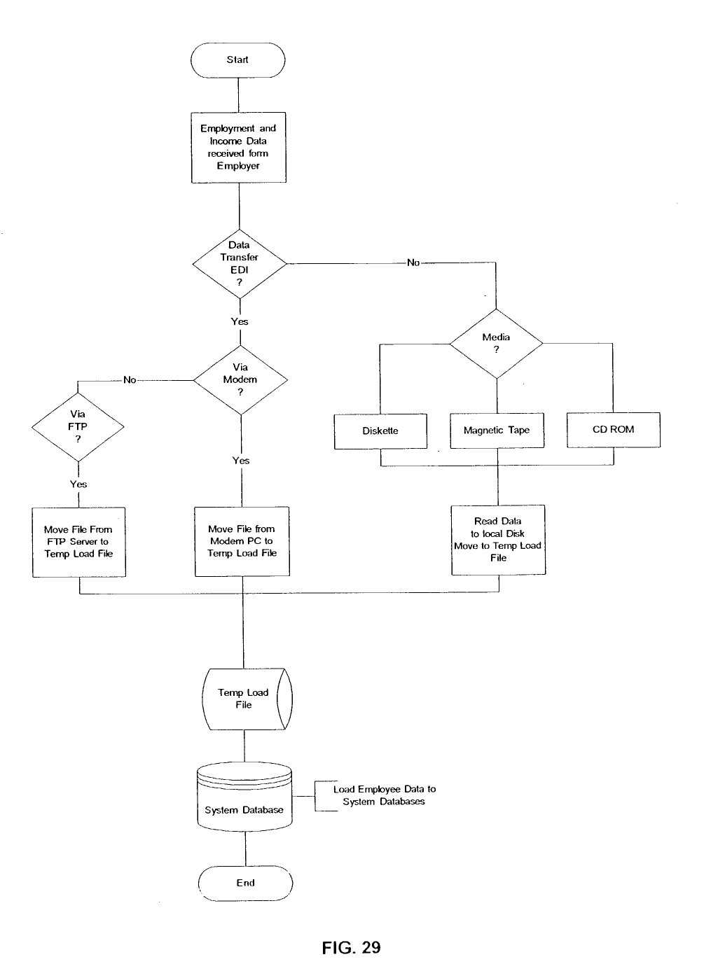

FIG. 29 is a flowchart for the employer 150 data load process described in the block diagram FIG. 26. The system first determines if the employer 150 data is being transferred to the service provider 154 by Electronic Data Interchange (EDI) or some other means. If the data is not being transferred EDI, the data will be transferred either through diskette, magnetic tape or CD ROM to the service provider 154 for loading to the primary database server 172 and the redundant database server 174.

If the employer data is being transferred EDI over a modem, the data moves to workstation 178. If the transferred data is compressed using PKZip, the data is uncompressed and prepared for loading. The data then moves through workstation 180 over the ethernet 168 to a temporary load area in primary database server 172 from where it is loaded to the production database in primary database server 172 and copied via the ethernet 168 to the redudant database server 174.

In the best mode, the employer 150 data is tranferred via the Internet 160 through the pipes 161, through router 162, through firewall 164 to FTP Server 166, utilizing File Transfer Protocol (FTP). The data is then moved from the FTP server 166 through the firewall 164 to the FTP Data Load 170 via the ethernet 168. If the received employee data is in encrypted form it is decrypted using the appropriate decryption software and prepared for loading. The data is then loaded via the ethernet 168 to a temporary load area on primary database server 172 from where it is loaded to the production database on the primary database server 172 and copied via the ethernet 168 to the redundant database server 174.

For purposes of claim interpretation the term “employment data” may include, but is not limited to, company identification code, employee PIN, SSN, employment status, i.e., actively employed, retired, no longer employed, etc.; most recent start date; total time with employer; current title; rate of pay, i.e., weekly, biweekly or monthly, etc.; average hours worked; total dollars paid, year to date; total dollars paid for prior years; last pay date and other types of employment data.

All of this employment data is stored in the primary database server 172 and is copied to the redundant database server 174. This employment data is transferred by the employer 150 periodically, typically following each pay period, so as to maintain the most accurate information possible. Transferring of employment data by the employer 150 does not require access to the service provider's 154 web site.

FIG. 29 is a flowchart that explains how the software functions when an 157, partner 152 a connection over the Frame Relay 158 with the service provider's 154 web server. Once the connection has been established, the partners 152 electronic interface sends an XML request for confirmation service. The service providers 154 electronic interface receives the request and validates that the request should be processed. If the request is invalid the inerface returns a error message to the partners 152 interface. The partners interface is designed to recognize error codes and act appropraitely. If the request is valid the service partners 154 interface then does a lookup and of the requested employees data record in primary database 172. If a record for the requested employee is not found the service provider 154 interface returns an appropriate error code to the partners 152 interface. If the requested record is found processing of the request is perfromed.

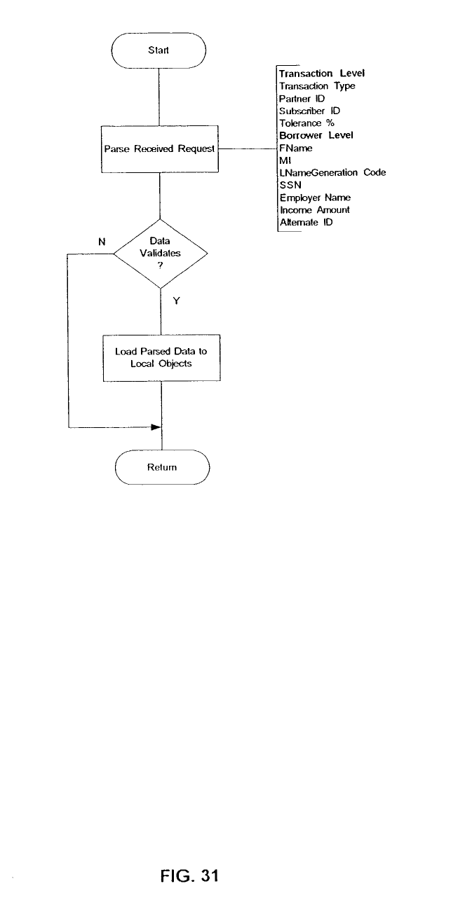

FIG. 31 is a flowchart explaining the XML parser routine used to process the request from the partners 152 interface. Applicant has found the following software suitable for the XML funtionality: MS Developer Environment 6.0 using MS Visual J++ 6.0 and MS Interdev 6.0 available from Microsoft Corporation of Redmond, Wash. Various fields from the received request are parsed and stored in approiate variables within the interface program. The content of the fields parsed are examined by the program for valid content. If fields are found to contain valid request data, processing continues. If fields do not contain valid data appropriate error messages are returned to the partner 152 interface. Various ways of designing interactive interfaces and various technologies for implementing active interfaces are well known to those skilled in the art and are within the scope of this invention.

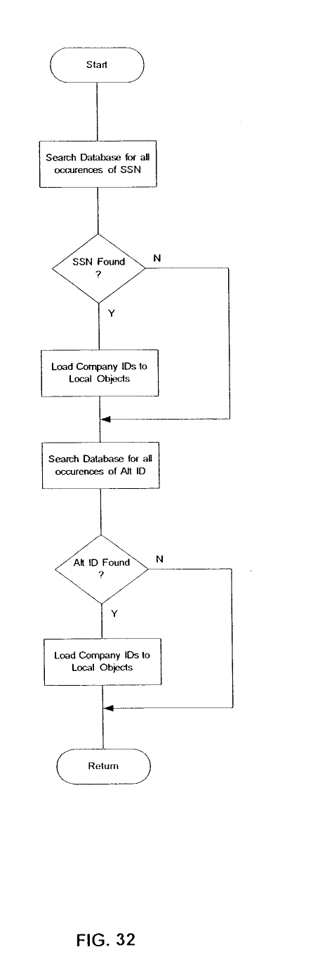

FIG. 32 is a flowchart that the explains the employee data lookup function. The program searches the primary database 172 for all occurences of the requested SSN. Any requested SSN may occur within the data multiple employers. For example an employee may have two jobs or an employee may have left one employer and moved to a different employer. Data records found in primary database 172 are loaded in program objects. The primary data key is employee Social Security Number. For various reasons some employers may choose to provide a Alternate ID as opposed to SSN. If the received confirmation request contains a value in the Alt ID field, the interface then searches primary database 172 for all occurrences of the Alt ID. Various methods and schemes for keying data and identifying data records are well known to those skilled in the art and are within the scope of this invention.

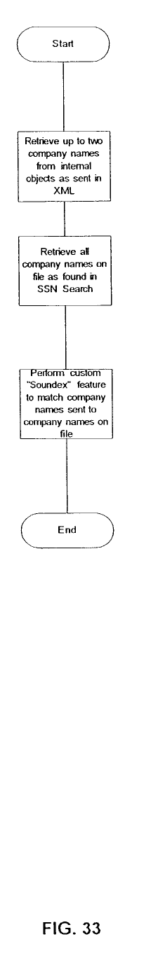

FIG. 33 is a flowchart of the software program for the recognition of employer 150 names received in the XML request from the partner 152 interface. Employer names supplied in the XML request are matched to the employer names that were found as a result of finding all occurences of the requested SSN in primary database 172. Matching the employer name supplied in the the XML request to the employer names found allows the interface to respond with employee data only from the requested employer. Various methods of matching data or data strings are well known to those skilled in the art and are within the scope of this invention.

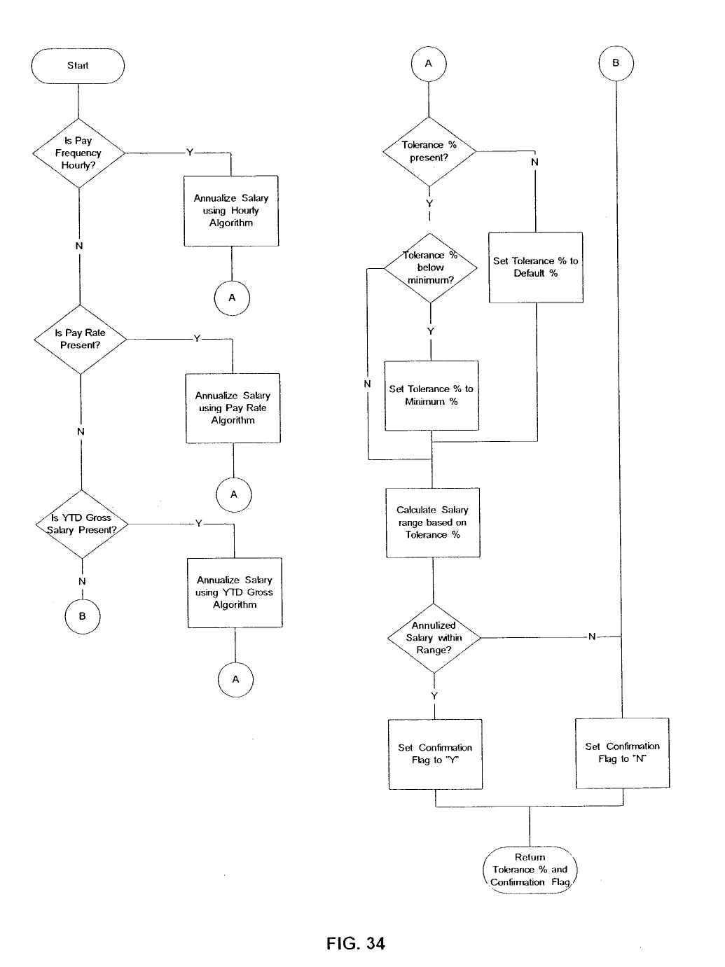

FIG. 34 is a flowchart of the software routine that is used when annual salary confirmation is requested. The presence of annual salary information, disclosed to the client 156, in the XML request triggers the interface to confirm the figure supplied. In addition, the client 156 may also supply a percentage tolerance for accuracy. The presence of a tolerance percent in the XML request is examined by the program for validity. A minimum tolerance of 7% has been set by the service provider 154, however other minimum tolerances are possible if agreed to by service provider 154 and partner 152. If disclosed annual salary information is present in the XML request but no accuracy tolerance is present or an invalid accuracy tolerance is present, the program defaults to an accuracy tolerance of 10%. Default tolerances may set at different levels as agreed to by the service provider 154 and the partner 152. Employee salary information fetched from primary database 172 is annualized using the appropriate algorithm based on what type of pay the employee receives. Various methods of accurately annualizing income are well known to those skilled in the art and will not be explained here. Annualized salary information calculated for the employee is compared to annual salary information supplied in the XML request from partner 152. If the calcualated annualized salary is below the supplied salary figure by the tolerance level or less or if the calculated annualized salary is equal to or greater than the annual salary figure supplied, the salary is confirmed. If the calcualated annualized salary is below the supplied salary figure by more than the toleance level, the salary is not confirmed. The interface will respond to a salary confirmation request in one of three ways: Yes, indicating the annual salary figure received in the request is confirmed; No, indicating the salary figure received in the request is not confirmed; No Calc, indicating that for some reason the supplied annual salary could niether be confirmed or not confirmed. The invention as it is now practiced is based upon the confirmation of annual salary, however other ways of confirming salary information such monthly, weekly, et al are within the scope of this invention. The system does not respond with exact salary information but rather confirms annual salary disclosed by the employee. Lack of an annual salary figure in the appropriate field of the received XML request indicates that no salary confirmation has been requested and the interface responds appropriately. The invention as it is now practiced examines a valid request for the presence or absence of key fields to determine appropriate action. Alternate ways of indicating to an interface how it is to respond, such as the use of flag fields et al, are well known to those skilled in the art and are within the scope of this invention.

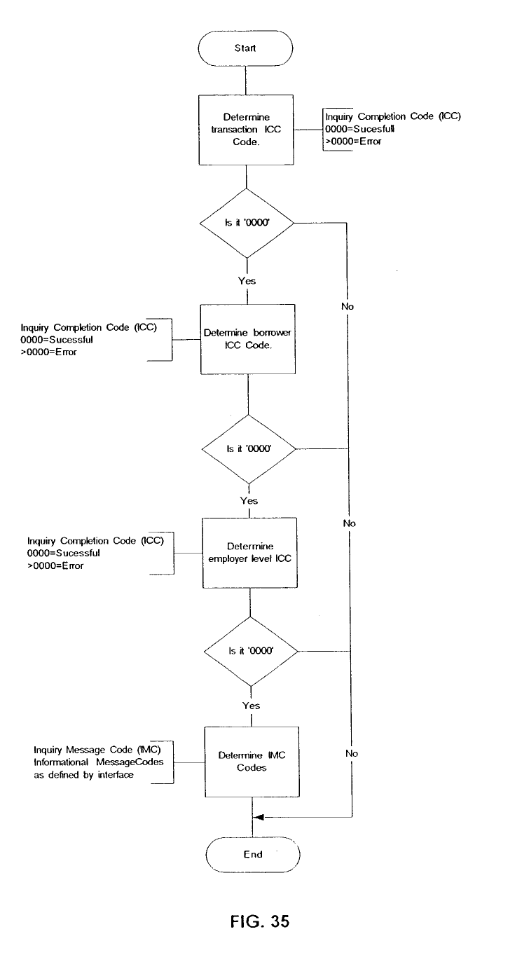

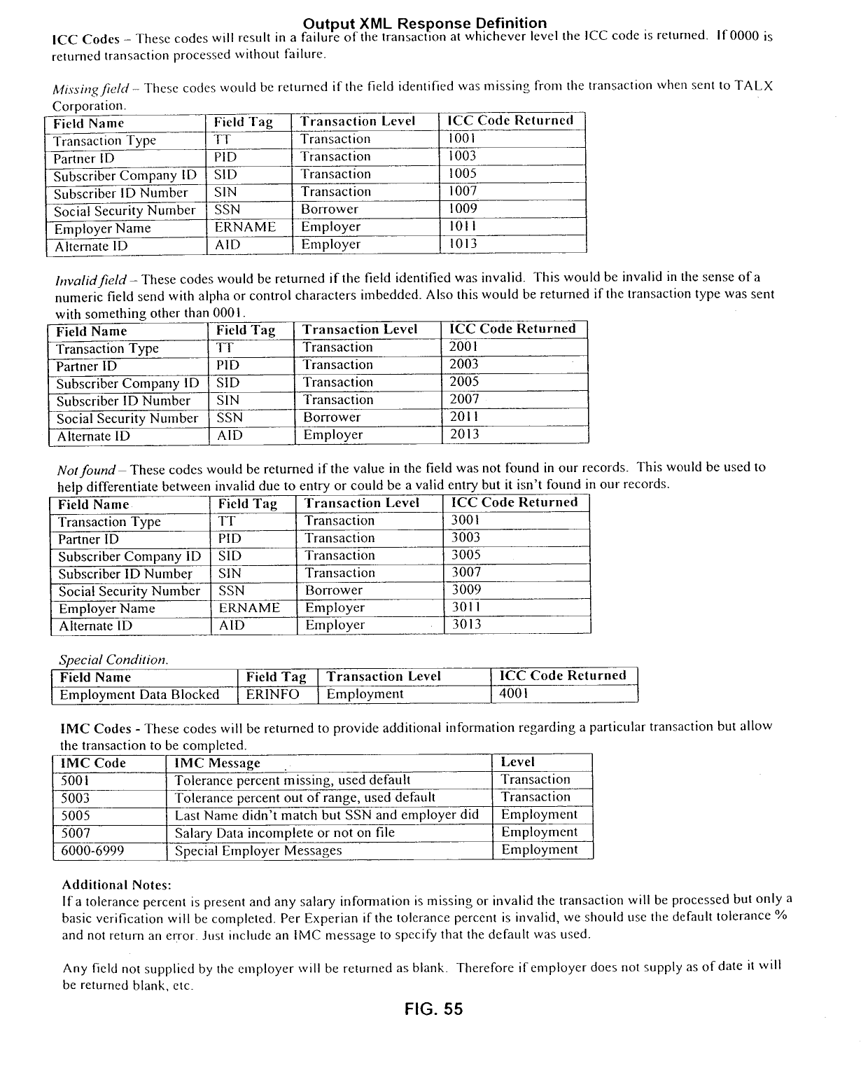

FIG. 35 is a flowchart of the software routine used to determine if an error has occurred in processing of the received request. Errors in processing may occur at three different levels in the process. Possible errors, error levels, and their associated codes are defined in FIG. 55. If all error code fields returned by the various interface routine are 0000 it indicates that that the request has been properly processed. The presence of certain major error codes will indicate that the request processing was unsucessful and respond to the partner 152 interface that no data other than the major error codes. I.e.—The receive XML request did not contain the employees SSN nor an Alternate ID therefore no processing could be accomplished. The presence of certain minor error codes will indicate that processing was successful but results may suspect or result in a partial data response to the partner 152 interface. Error response handling by the partner 152 interface to the verifer 156 is the responsibility of the partners 152 interface. I.E.—an annual salary confirmation could not be processed due to incomplete salary data in primary database 172, however basic employment data is sucessfully being supplied.

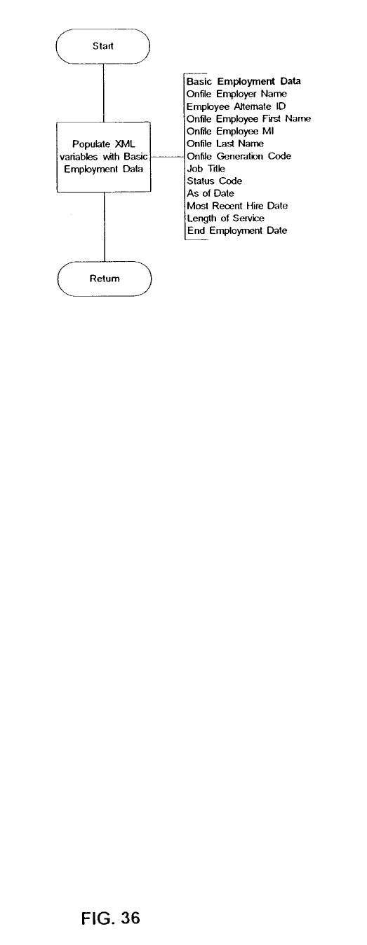

FIG. 36 is a flowchart of the software routine used to fetch and store basic employment data in response to a valid request for return to partner 152 interface. Data is fetched from the primary database 172 and includes but is not limited to: date of confirmation (supplied by the system), current as of date (date of last data update or employer pay date), employer name, employee name, employee's SSN, employment status (active, inactive, retired, etc.), employee's most recent start date, total time in years and months the employee has been with the employer, current job title, and verification reference number (supplied by the system). Some optional data fields may or may not be supplied to service provider 154 and left to the discretion of the employer. Data not supplied by the employer will be returned as a blank field.

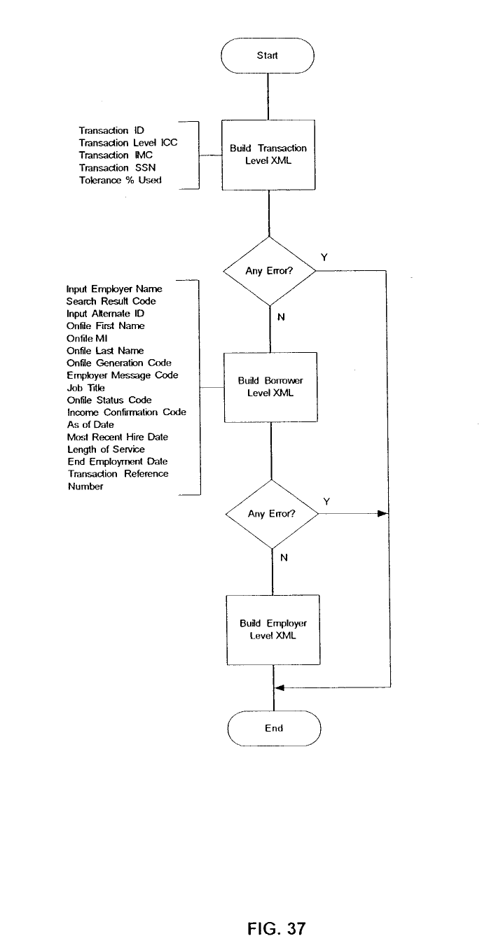

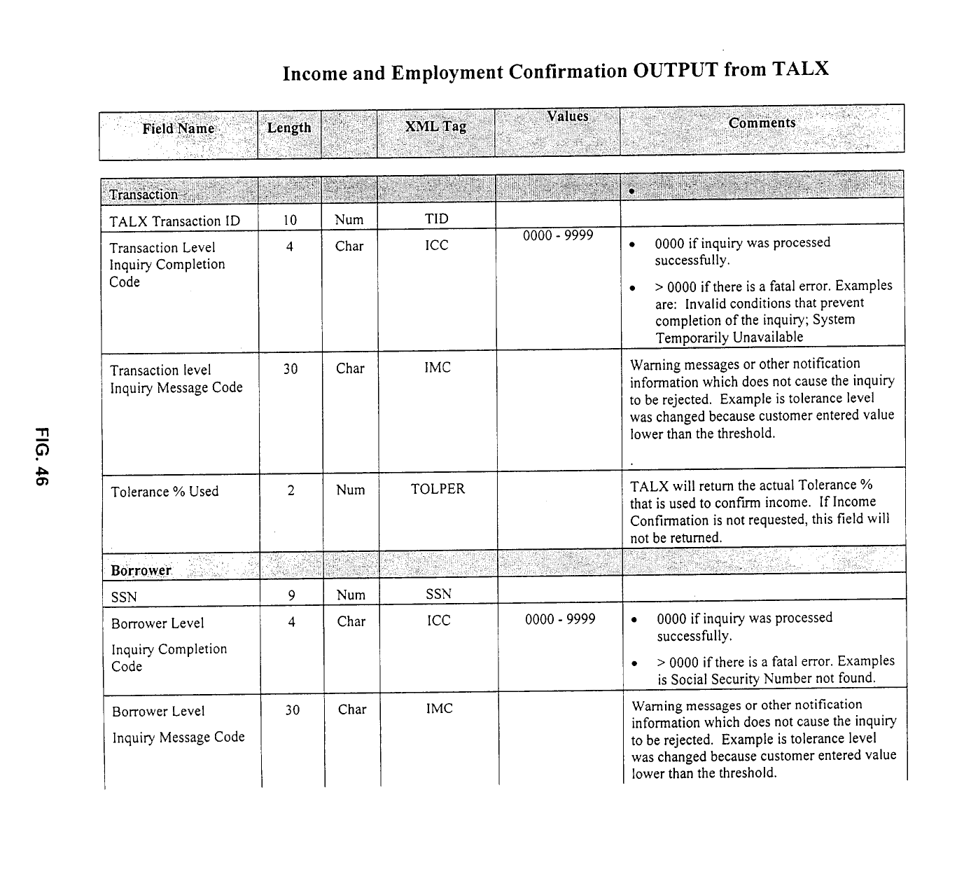

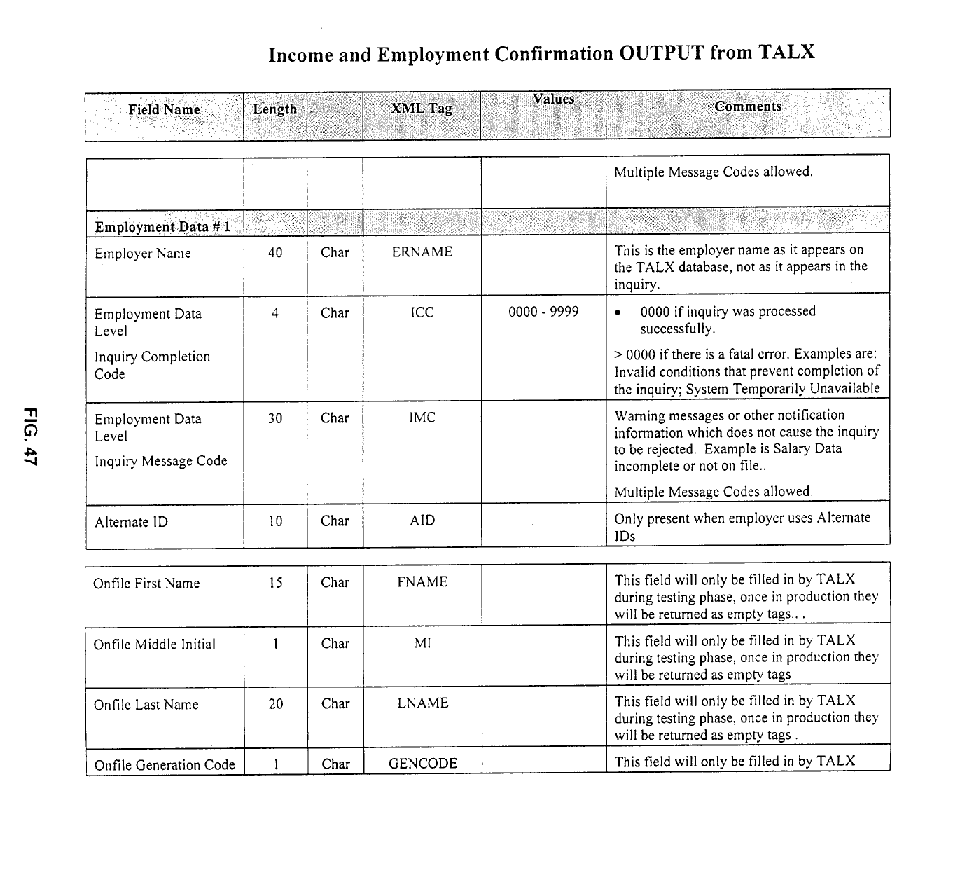

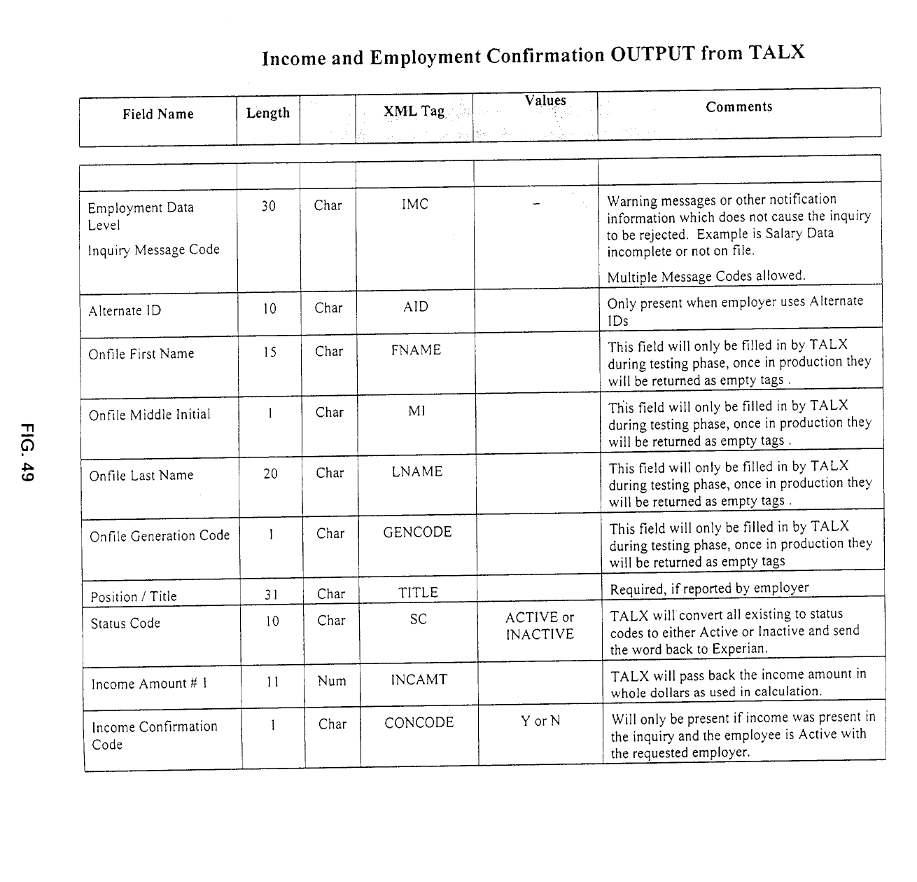

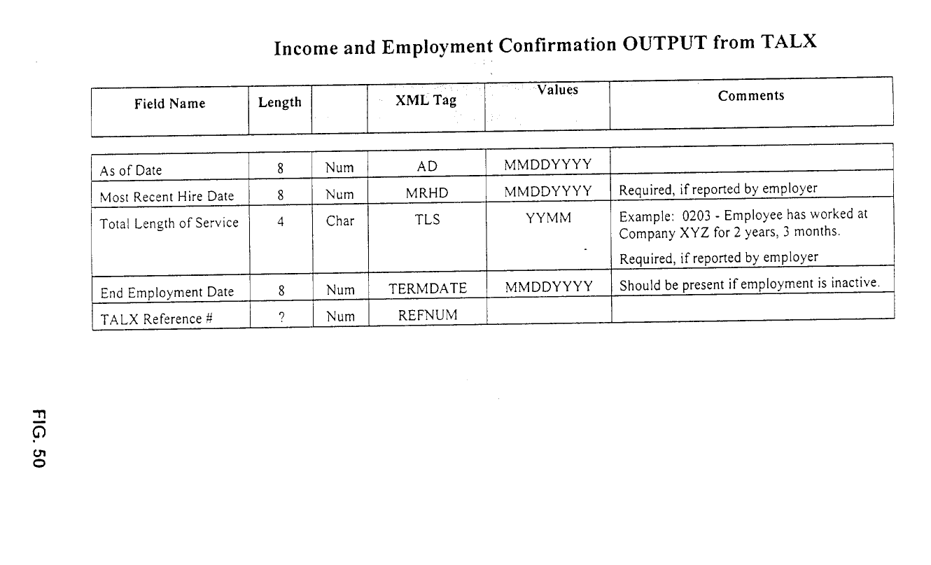

FIG. 37 is a flowchart for the software used to build an XML response to the partner 152 interface. Applicant has found the following software suitable for the XML funtionality: MS Developer Environment 6.0 using MS Visual J++ 6.0 and MS Interdev 6.0 available from Microsoft Corporation of Redmond, Wash. The service provider 154 interface builds an XML response stream appropriate to processing that has occurred. XML response field definition is defined in FIG. 46 and continuation FIGS. 47, 48, 49, and 50.

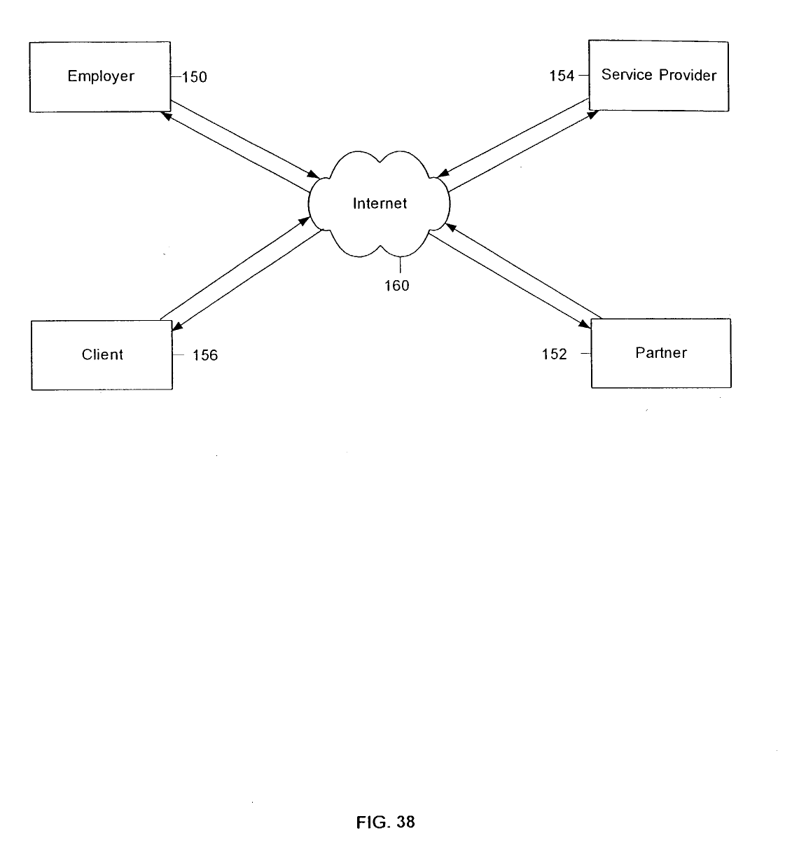

FIG. 38 is a block diagram of an alternative embodiment of this invention. This block diagram differs from the diagram in FIG. 25 in that no frame relay 158 is utilized. The interface functionality is unchanged except that the connection between the partner 152 and the service provider 154 is across the internet 160.

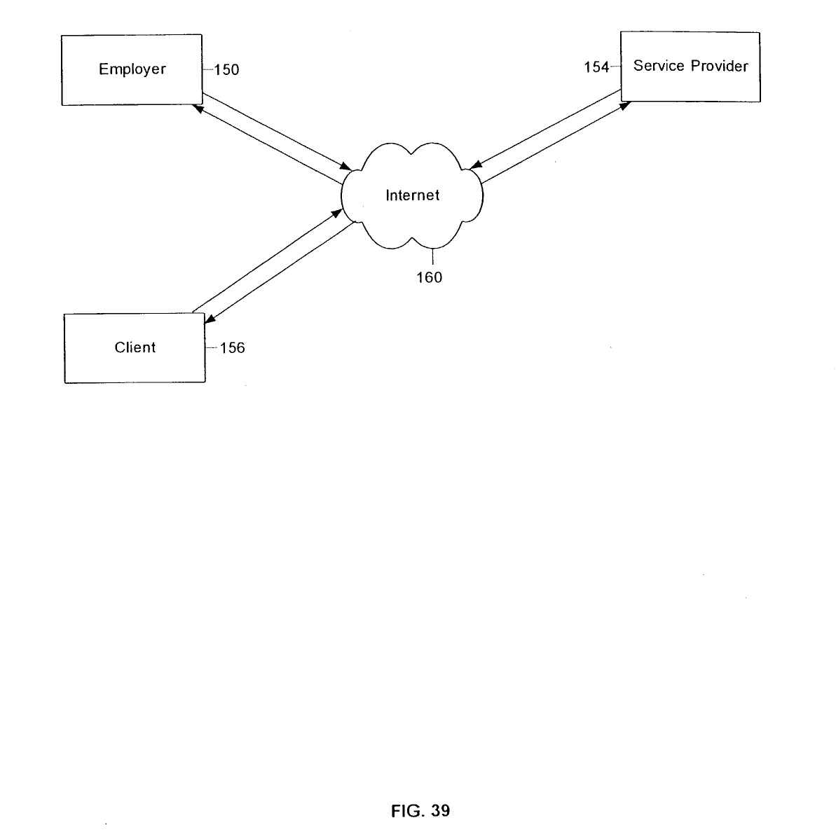

FIG. 39 is a block diagram of an alternative embodiment of this invention showing the Client 156 connection directly to service provider 154 via the internet 160 with no partner 152. In this embodiment the client 156 enters into an agreement for confirmation services directly with service provider 154. Further, In this embodiment system functionality is unchanged with the exception of the user interface and billing procedures. In this embodiment the user interface may be supplied by the client 156 themselves or by the service provider 154 as defined in the service agreement. Also in this embodiment billing and collection responsibility become the responsibility of the service provider 154.

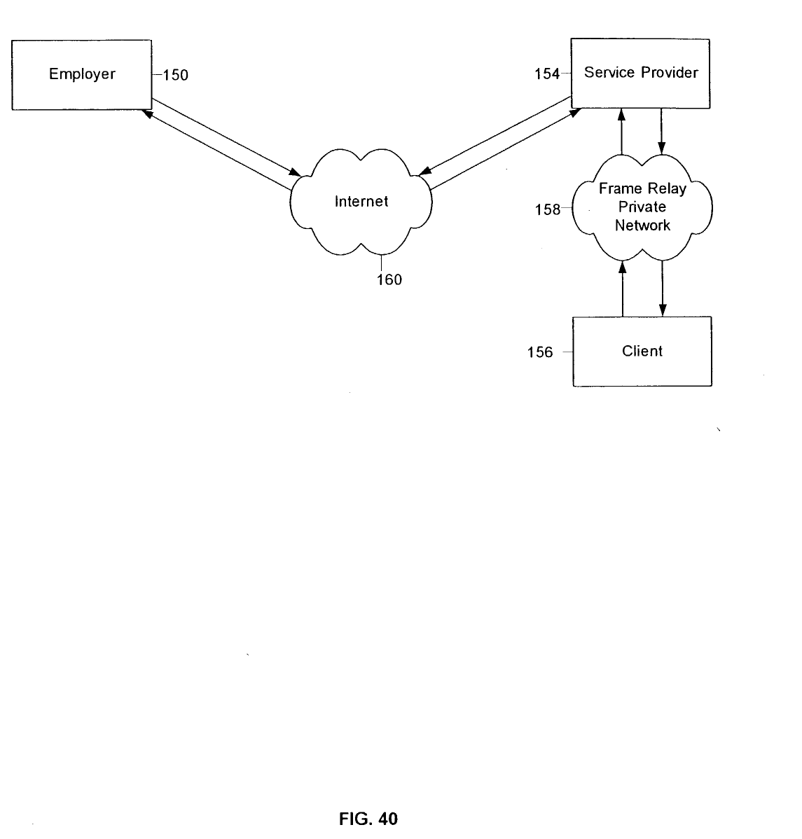

FIG. 40 is a block diagram of an alternative embodiment of this invention showing the Client 156 connection directly to service provider 154 via Frame Relay 158 with no partner 152. In this embodiment the client 156 enters into an agreement for confirmation services directly with service provider 154. Further, In this embodiment system functionality is unchanged with the exception of the user interface and billing procedures. In this embodiment the user interface may be supplied by the client 156 themselves or by the service provider 154 as defined in the service agreement. Also in this embodiment billing and collection responsibility become the responsibility of the service provider 154.

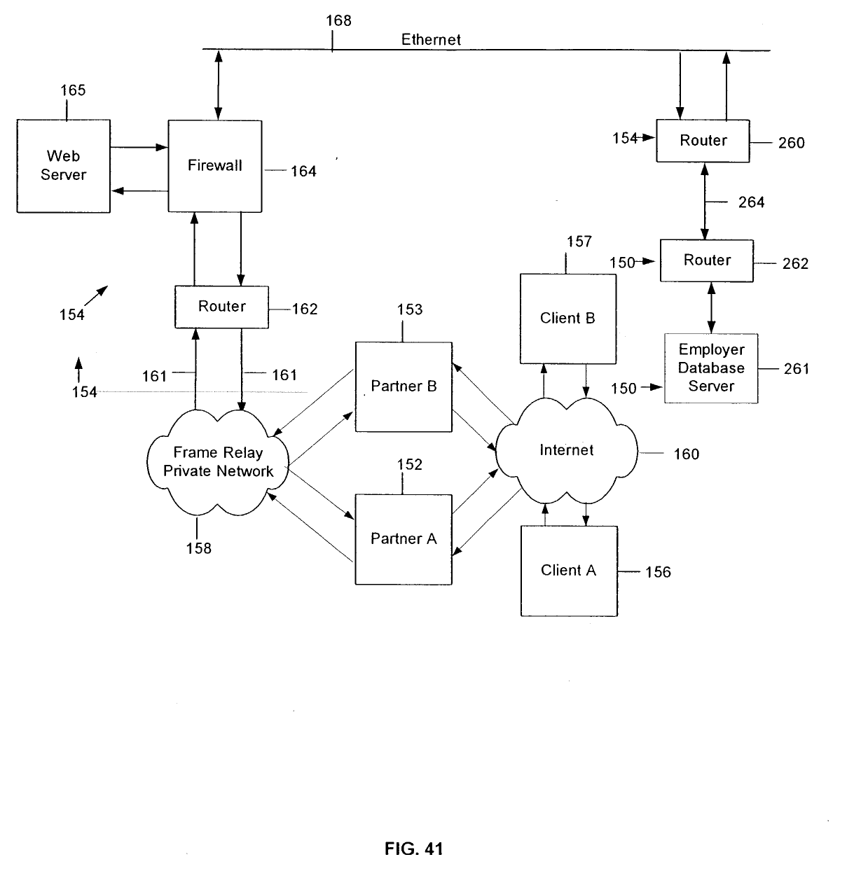

FIG. 41 is an alternative embodiment of the verification system of FIG. 38. This block diagram differs from the diagram in FIG. 28 because the duties and functions of the service provider 154 have been subsumed by the employer 150 In this alternative embodiment, the database servers are maintained by or for the employer 150 and the employer 150 may or may not charge for reports generated. This alternative embodiment provides a system to an employer 150 that wishes to keep the confirmation process in-house, or at least partially in-house.

In this alternative system, the employer 150 loads the employment data directly on to the employer's database servers 110 and 112 and updates them on a periodic basis in the same fashion as it would if this employment data was being transferred to the database servers 172 and 174 of the service provider 154. However, in this alternative embodiment, the database server 261 is located at the employer's 150 place of business or are maintained by a third party on behalf of the employer 150. In this alternative embodiment, the connections made between the service provider 154 and employer 150 may or may not utilize SSL technology for encryption. Other types of encryption methods known to those skilled in the art are within the scope of this invention. Basic system functionality is as previously described, but employee and slalry data for confirmation service is maintained by or under the control of the employer 150.

In FIG. 28, multiple verifiers 156, 157 simultaneously access the partner 152 over the Internet 160 and multiple partners access the service provider 154 over Frame Relay 158. Upon valaidation, mutilple responses from multiple employers are sent back to multiple partners 152, 153 simueltaeously for return to multiple clients 156, 157 over the internet 160. In FIG. 25, the primary database server 172 and the redundant database server 174 are located at the service provider's place of business or they are maintained offsite under the servicer provider's 154 control. In the alternative embodiment of FIG. 41, the primary database server 261 is located at the employer's 150 place of business or offsite under the employer's 150 control. This alternative configuration is attractive to employers 150 that do not wish to relinquish control of their employment data to a third party, i.e., the service provider 154.

In the alternative embodiment of FIG. 41, the verifiers 156, 157 connect to the partner 152, 153, as previously described. A properly authorized request is sent over ethernet 168 to a router 154 which accesses the employer 150 database 261 over a connection, for example, a leased telephone line 264. The employment and salary data for a confirmation is sent from the employer database 261 over leased line 264, through router 154 across ethernet 168 to firewall 164 to the service provider web server 165 where a confirmation request, previously described, is performed and sent back to the firewall 164, through router 162 and connection 161 to the Frame Relay 158 to the partners 152, 153 and finally to the verifiers 156, 157 via the internet 160. In this alternative embodiment the connections made between the service provider 154 and employer 150 may or may not utilize SSL technology for encryption. Other types of encryption methods known to those skilled in the art are within the scope of this invention.

The service provider 154 typically will have the followig hardware/software at its place of business: router 154, firewall 164, web server 2165 ethernet 168 and router 154. The employer 150 will have the following hardware/software at its place of business: router 262 and employer database server 261.

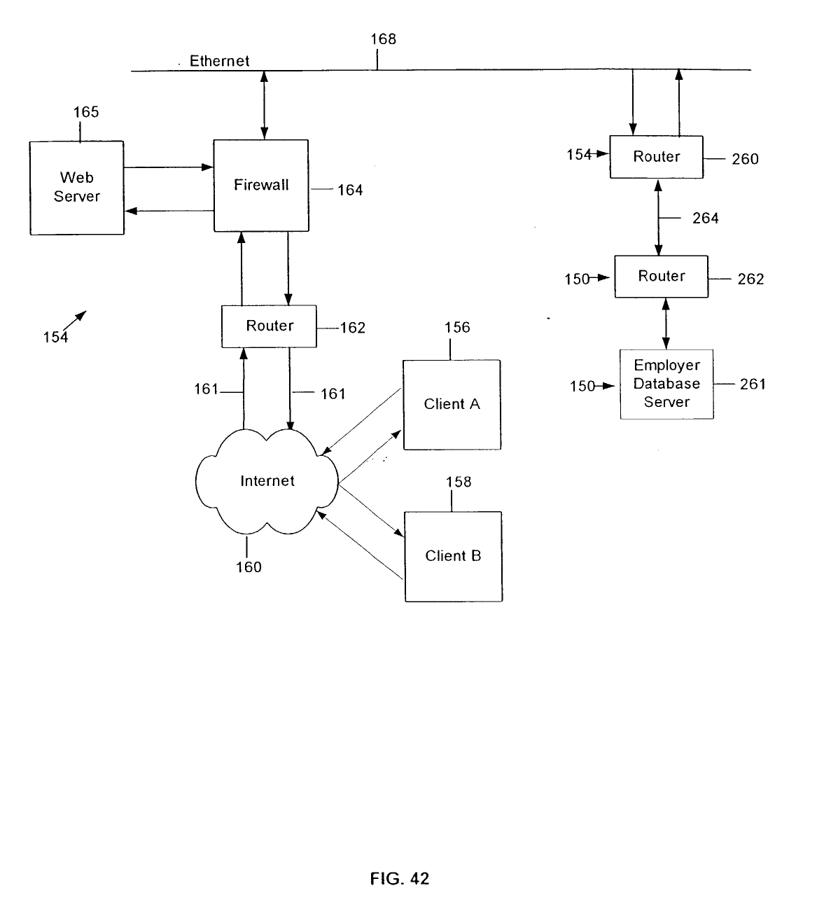

FIG. 42 is a block diagram of an alternative embodiment of this invention similar to FIG. 39. System functionality is as described in FIG. 39 with the exception that the duties and functions of the service provider 154 have been subsumed by the employer 150 as described in FIG. 41.

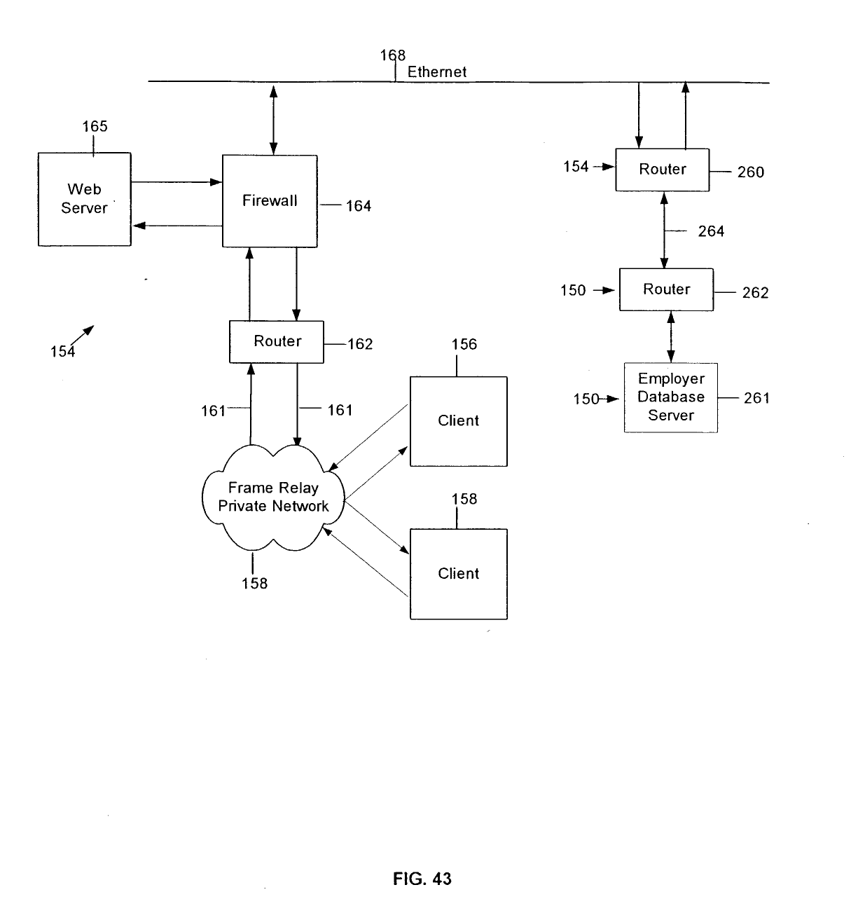

FIG. 43 is a block diagram of an alternative embodiment of this invention similar to FIG. 40. System functionality is as described in FIG. 40 with the exception that the duties and functions of the service provider 154 have been subsumed by the employer 150 as described in FIG. 41.

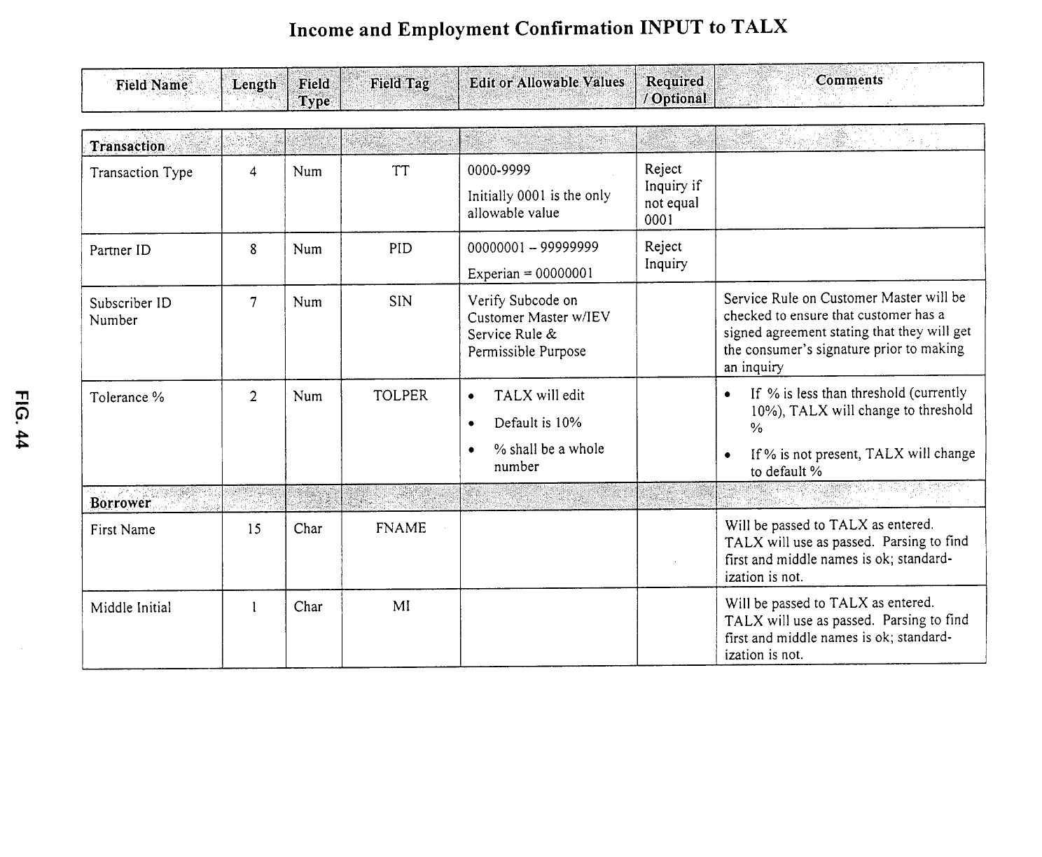

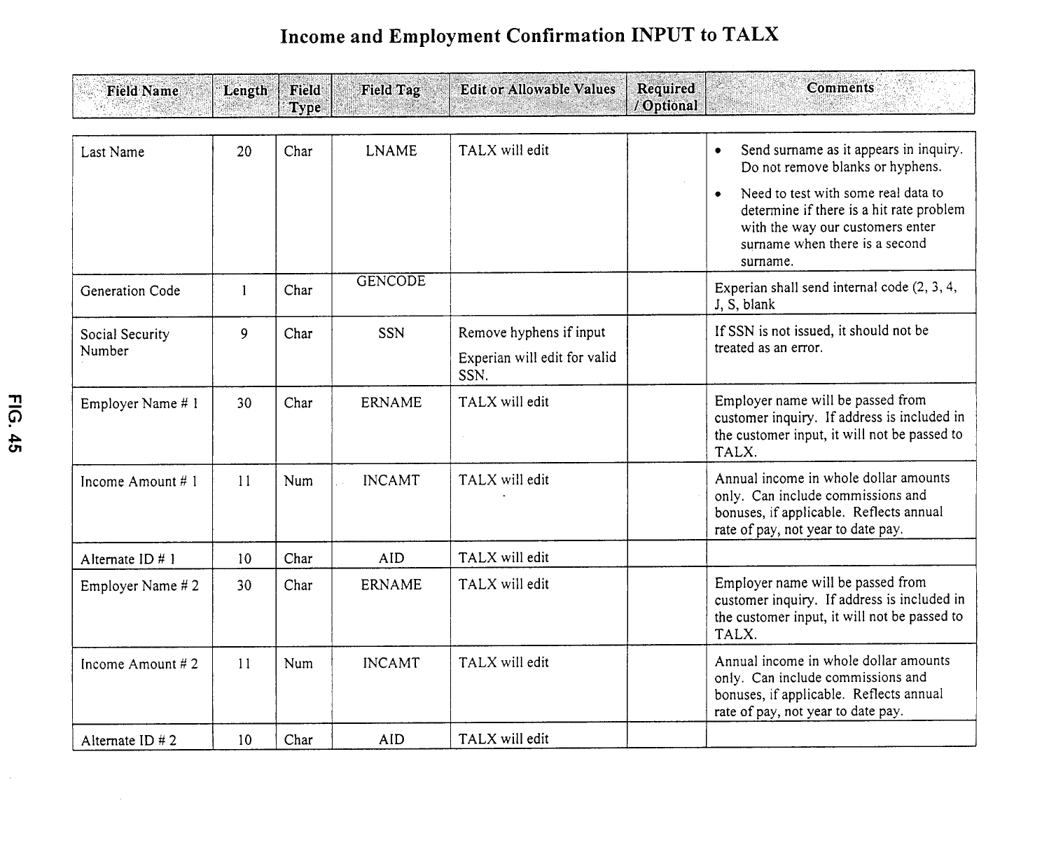

FIG. 44 and continued on FIG. 45 are the electronic interface request field definitions received by service provider 154. Various field definitions for an input request could be further defined or added and are well known to those skilled in the art. Various input field definitions are within the scope of this invention.

FIG. 46 continued on FIGS. 47, 48, 49, and 50 are the electronic interface output field definitions to a request input received by service provider 154. Various output field definitions in response to an input request could be further defined or added and are well known to those skilled in the art. Various input field definitions are within the scope of this invention.

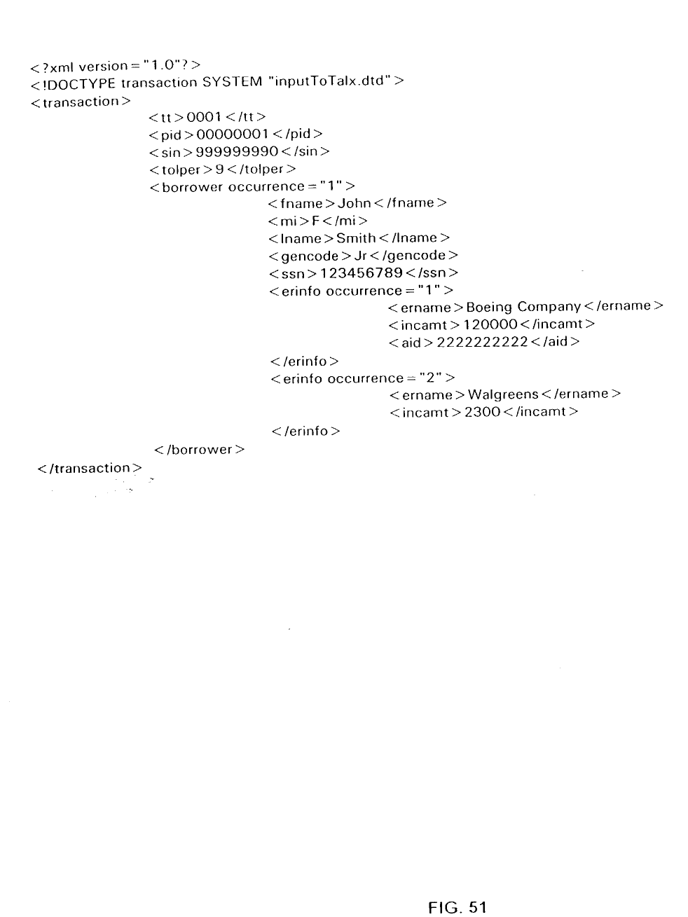

FIG. 51 is an example of a correctly formatted XML request stream received by the service provider 154 and corresponds to field definitions in FIGS. 44 and 45. An XML input stream is used as the invention is practiced today. Other Less efficient methods of formatting and supplying an input request stream could be used, such as HTML, are well known to those skilled in the art and are within the scope of this invention.

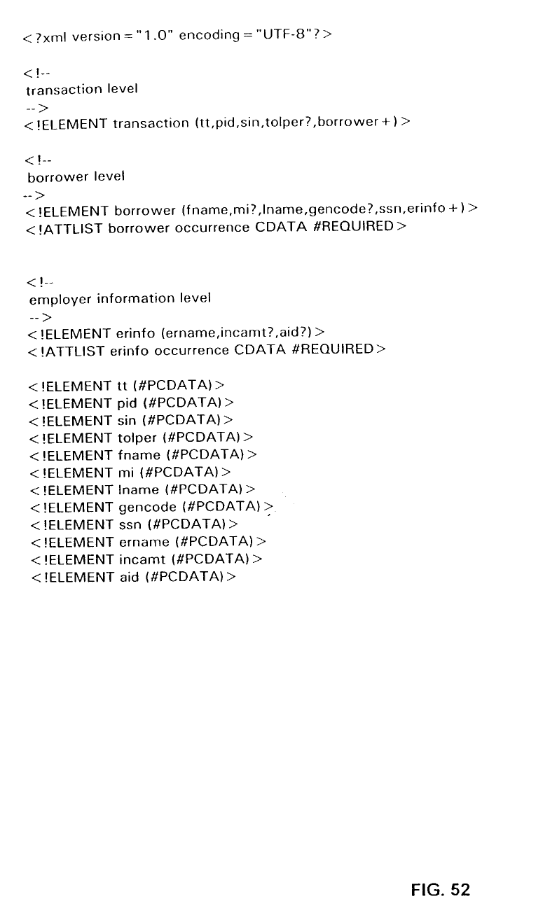

FIG. 52 is the Data Type Definition (DTD) for an XML input request stream. The XML parser uses the DTD to validate that a request received by the service provider 154 is correctly formatted and can be processed. Various DTDs could be developed for varing input request streams or not required, such as in the case of HTML. The need or lack there of for a DTD or similar definition set are well known to those skilled in the art. The content of a DTD or similar definition set is defined by valid fields that are to be received as part of an input request stream. Various methods for determining that a received request is correctly formatted are well known to those skilled in the art and within the scope of this invention.

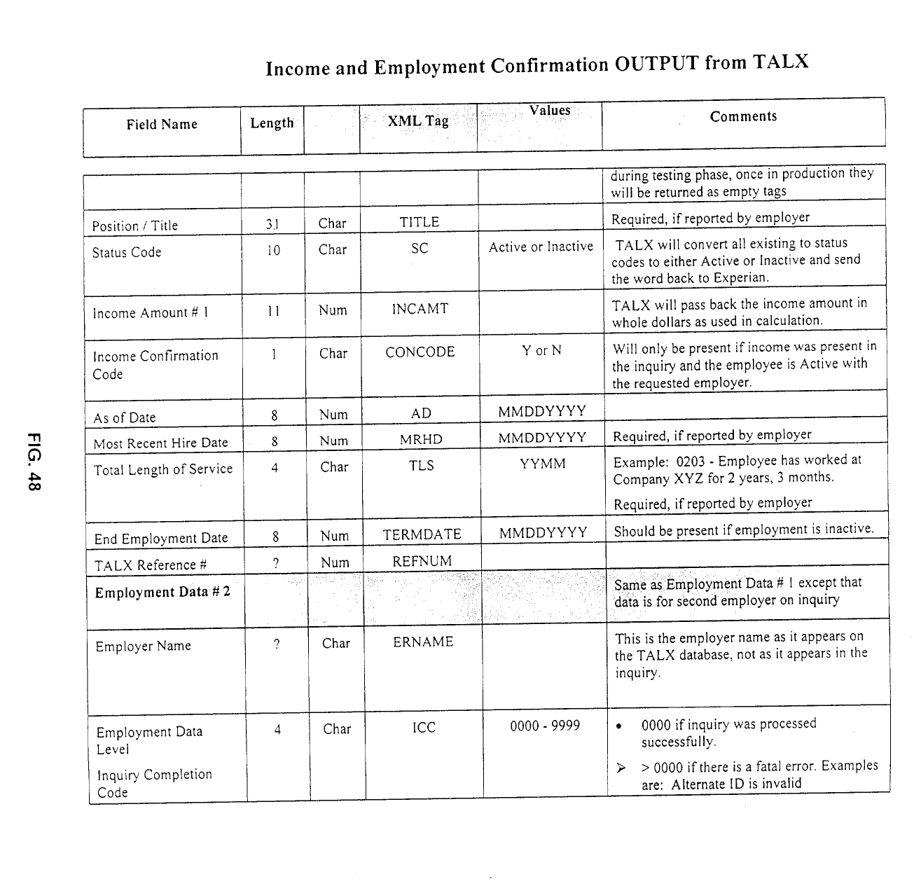

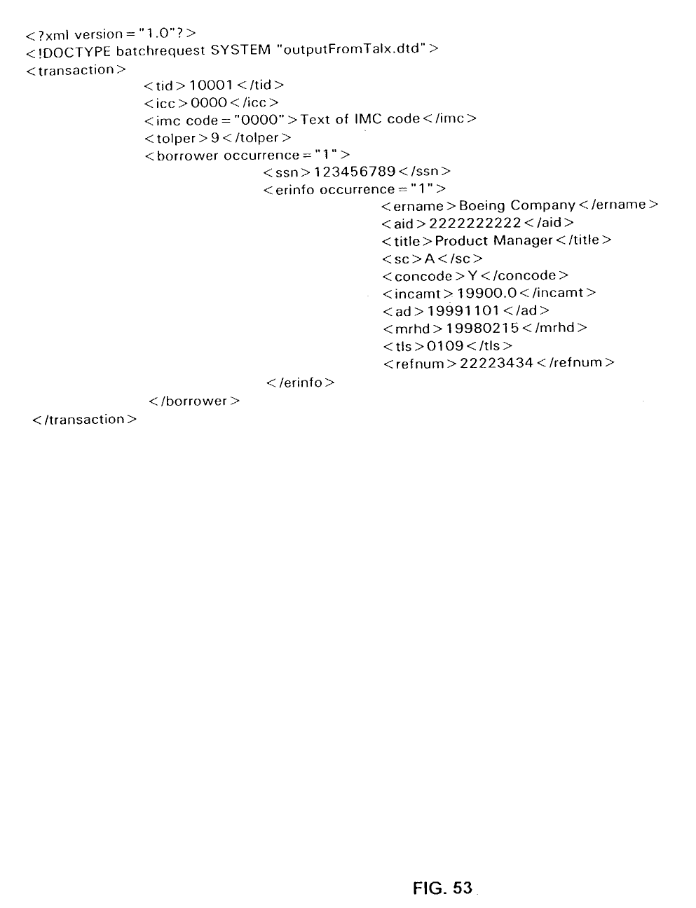

FIG. 53 is an example of a correctly formatted XML output response stream received by partner 152 in response to a valid confirmation request and corresponds to output field definitions in FIG. 46 and continued on FIGS. 47, 48,49, and 50. An XML output stream is used as the invention is practiced today. Other less efficient methods of formatting and supplying an output response stream could be used, such as HTML, are well known to those skilled in the art and are within the scope of this invention.

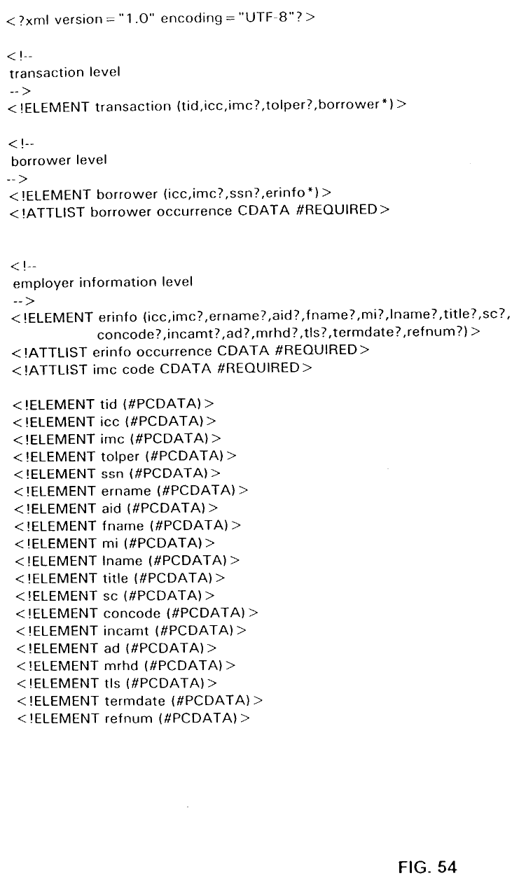

FIG. 54 is the Data Type Definition (DTD) for an XML output response stream. The partner's 152 XML parser uses this DTD to validate that a respose stream received by the partner 152 is correctly formatted and has been properly processed. Various DTDs could be developed for varing output response streams or not required, such as in the case of HTML. The need or lack there of for a DTD or similar definition set are well known to those skilled in the art. The content of a DTD or similar definition set is defined by valid fields that are to be received as part of an output response stream. Various methods for determining that a received output response is correctly formatted are well known to those skilled in the art and within the scope of this invention.

FIG. 55 is a table showing detailed definition of various fields within the XML output response stream. Various fields and codes defined within the XML output response stream define different error or information codes to the partner 152. From time to time, other types of codes and definitions may be added or deleted as necessary. Supplying error and information codes is common in electronic interfaces. Various schemes for defining and delivering error and information codes, such as HTML screens or separate XML output, are well known to those skilled in the art and are within the scope of this invention.

What is claimed is:

1. A method for a service provider and a partner to respond to inquiries from a client to disclose credit information and to verify the accuracy of employment data in a credit application over the global computer network for a plurality of employees from at least one employer that maintains a computer system which connects to the global computer network, the method comprising:
Maintaining a service provider computer system that is capable of sending and receiving data over the global computer network;
Transmitting over the global computer network employment data from the employer computer system to the service provider computer system and storing the employment data in the service provider computer system;
Maintaining a partner computer system that is capable of sending and receiving data over the global computer network;
Storing credit information in the partner computer system;
Maintaining a frame relay private network between the service provider and the partner to allow them to communicate and exchange data quickly and confidentially;
Sending an inquiry from the partner over the frame relay private network to the service provider requesting verification that employment data contained in a credit application that has been completed by a specific employee is accurate;
Comparing the employment data in the credit application with employment data in the service provider computer system and sending a report over the frame relay private network to the partner concerning the accuracy of the data in the application; and
Sending a report from the partner to the client over the global computer network containing credit information about this specific employee and verification or denial that the employment data in the credit application is accurate.

2. A method for a service provider and a partner to respond to inquiries from a client to disclose credit information and to verify the accuracy of employment data in a credit application over the global computer network for a plurality of employees from at least one employer that maintains a computer system which connects to the global computer network, the method comprising:
Maintaining a service provider computer system that is capable of sending and receiving data over the global computer network;
Transmitting over the global computer network employment data from the employer computer system to the service provider computer system and storing the employment data in the service provider computer system;
Maintaining a partner computer system that is capable of sending and receiving data over the global computer network;
Storing credit information in the partner computer system;
Sending an inquiry from the partner over the global computer network to the service provider requesting verification that employment data contained in a credit application that has been completed by a specific employee is accurate;
Comparing the employment data in the credit application with employment data in the service provider computer system and sending a report over the global computer network to the partner concerning the accuracy of the data in the application; and
Sending a report from the partner to the client over the global computer network containing credit information about this specific employee and verification or denial that the employment data in the credit application is accurate.

3. A method for a service provider to respond to inquiries from a client to disclose credit information and to verify the accuracy of employment data in a credit application over the global computer network for a plurality of employees from at least one employer that maintains a computer system which connects to the global computer network, the method comprising:
Maintaining a service provider computer system that is capable of sending and receiving data over the global computer network;
Transmitting over the global computer network employment data from the employer computer system to the service provider computer system and storing the employment data in the service provider computer system
Storing credit information in the service provider computer system;
Sending an inquiry from the client over the global computer network to the service provider requesting verification that employment data contained in a credit application that has been completed by a specific employee is accurate and requesting credit information about this specific employee;
Comparing the employment data in the credit application with employment data in the service provider computer system to determine the accuracy of the data in the application; and
Sending a report from the partner to the client over the global computer network containing credit information and verification or denial that the employment data in the credit application is accurate.

4. A method for a service provider to respond to inquiries from a client to disclose credit information and to verify the accuracy of employment data in a credit application over a frame relay private network for a plurality of employees from at least one employer that maintains a computer system which connects to the global computer network, the method comprising:
Maintaining a service provider computer system that is capable of sending and receiving data over the global computer network;
Transmitting over the global computer network employment data from the employer computer system to the service provider computer system and storing the employment data in the service provider computer system;
Storing credit information in the service provider computer system;
Maintaining a frame relay private network between the service provider and the client to allow them to communicate and exchange data quickly and confidentially;
Sending an inquiry from the client over the frame relay private network to the service provider requesting verification that employment data contained in a credit application that has been completed by a specific employee is accurate and further requesting credit information about this specific employee;
Comparing the employment data in the credit application with employment data in the service provider computer system and sending a report over the frame relay private network to the client concerning the accuracy of the data in the application; and
Sending a report from the service provider to the client over the global computer network containing credit information and verification or denial that the employment data in the credit application is accurate.
